(19) United States
(12) Patent Application Publication
(10) Pub. No.: US 2026/0220283 A1
(43) Pub. Date: Jul. 30, 2026

(54) INFORMATION PROCESSING SYSTEM, INFORMATION PROCESSING APPARATUS, AND INFORMATION PROCESSING METHOD

(71) Applicant: Genki WATANABE, Tokyo (JP)

(72) Inventor: Genki WATANABE, Tokyo (JP)

(21) Appl. No.: 19/439,511

(22) Filed: Jan. 5, 2026

(30) Foreign Application Priority Data
Jan. 29, 2025 (JP) 2025-012621
Sep. 29, 2025 (JP) 2025-162348

(51) Int. Cl. G06F 21/60; G06F 21/62

(52) U.S. Cl. CPC G06F 21/604; G06F 21/6218

(57) ABSTRACT

An information processing system includes: a memory that stores information related to access rights and electronic data; and circuitry to receive an input of an input message to an interactive artificial intelligence (AI) that interacts with a user who has logged in; search the memory based on the input message to obtain a search result; and display, on a display, electronic data to which the user has an access right among the electronic data stored in the memory, as a response of the interactive AI to the input message, based on the search result.

### CROSS-REFERENCE TO RELATED APPLICATIONS

This patent application is based on and claims priority pursuant to 35 U.S.C. § 119(a) to Japanese Patent Application Nos. 2025-012621, filed on Jan. 29, 2025, and 2025-162348, filed on Sep. 29, 2025, in the Japan Patent Office, the entire disclosure of each is hereby incorporated by reference herein.

### BACKGROUND

### Technical Field

The present disclosure relates to an information processing system, an information processing apparatus, and an information processing method.

### Related Art

A technique that generates output information such as text data using existing document data is known.

However, an access to electronic data is not controlled when an interactive artificial agent (AI) is used. For example, electronic data or a response message generated using the electronic data may be displayed on a terminal apparatus operated by a user who has no access right to the electronic data.

### SUMMARY

The present disclosure described herein provides an information processing system including a memory that stores information related to access rights and electronic data; and circuitry to: receive an input of an input message to an interactive artificial intelligence (AI) that interacts with a user who has logged in; search the memory based on the input message to obtain a search result; and display, on a display, electronic data to which the user has an access right among the electronic data stored in the memory, as a response of the interactive AI to the input message, based on the search result.

The present disclosure described herein provides an information processing apparatus including circuitry to: receive an input of an input message to an artificial intelligence (AI) that interacts with a user who has logged in; search a memory that stores information related to access rights and electronic data based on the input message to obtain a search result; and display, on a display, electronic data to which the user has an access right among the electronic data stored in the memory, as a response of the interactive AI to the input message, based on the search result.

The present disclosure described herein provides an information processing method including: receiving an input of an input message to an interactive artificial intelligence (AI) that interacts with a user who has logged in; searching a memory that stores information related to access rights and electronic data based on the input message to obtain a search result; and displaying, on a display, electronic data to which the user has an access right among the electronic data stored in the memory, as a response of the interactive AI to the input message, based on the search result.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system;

FIG. 2 is a diagram illustrating an example of a hardware configuration of an information processing apparatus and a terminal apparatus;

FIG. 3 is a diagram illustrating an example of a functional configuration of the information processing system;

FIG. 4 is a table presenting an example of chunk information stored in a data storage unit;

FIG. 5 is a table presenting an example of agent information stored in an agent information storage unit;

FIG. 6 is a table presenting an example of items of database linkage included in the agent information;

FIG. 7 is a table presenting an example of user information stored in a user information storage unit;

FIG. 8 is a sequence diagram presenting an example of operations and processes performed by the information processing system;

FIG. 9 is a sequence diagram presenting an example of operations and processes performed by the information processing system for a process of responding to an input message;

FIG. 10 is a flowchart presenting an example of details of the process performed by an access control unit in step S32 in FIG. 9;

FIG. 11 is a flowchart presenting an example of details of the process performed by the access control unit in step S41 in FIG. 9;

FIG. 12 is a view illustrating an example of display of an interactive screen at the start of conversation;

FIG. 13 is a view illustrating an example of display of output information;

FIG. 14 is a view illustrating an example of display of an error message displayed on the terminal apparatus when a user has no account for a database;

FIG. 15A is a view illustrating an example of display of an error message displayed on the terminal apparatus when document data to which the user has an access right is not found although the data storage unit is searched;

FIG. 15B is a view illustrating an example of display of document data that matches the search and document data that does not match the search in the data storage unit;

FIG. 16 is a conceptual diagram illustrating an example of a process in which an agent acquires document data from a database;

FIG. 17 is a conceptual diagram illustrating an example of a process in which a user A uses the agent to display a response message;

FIG. 18 is a conceptual diagram illustrating an example of a process in which a user B uses the agent to display a response message;

FIG. 19 is a conceptual diagram illustrating an example of a process in which a user C uses the agent to display a response message;

FIG. 20 is a view illustrating an example of an error message displayed on the terminal apparatus when the user has no account for the database;

FIG. 21 is a view illustrating an example of an approval message displayed on the terminal apparatus when an approval user approves use of an account;

FIG. 22 is a view illustrating an example of the interactive screen displayed on the terminal apparatus when the approval user having an access right to a database to be accessed by a qualified agent is not found;

FIG. 23 is a view illustrating an example of a non-approval message displayed on the terminal apparatus when the use of the account is not approved;

FIG. 24 is a view illustrating an example of the interactive screen displayed on the terminal apparatus operated by the approval user;

FIG. 25 is a sequence diagram presenting an example of operations and processes performed by the information processing system when the user A has no account for the database;

FIG. 26 is a sequence diagram presenting an example of a flow of processing when the approval user approves and when the approval user does not approve;

FIG. 27 is a sequence diagram presenting an example of operations and processes performed by the information processing system when the user A has no access right to the document data;

FIG. 28 is a sequence diagram presenting an example of a flow of processing when the approval user approves and when the approval user does not approve;

FIG. 29 is a view illustrating an example of the interactive screen displayed on the terminal apparatus when the approval user does not approve the access right to document data included in a search result;

FIG. 30 is a view illustrating an example of the interactive screen displayed by the terminal apparatus used by the approval user in step S66;

FIG. 31 is a diagram illustrating an example of a functional configuration of a terminal apparatus according to a third embodiment; and

FIG. 32 is a sequence diagram presenting an example of a procedure of a process of displaying a response message according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and an information processing method performed by the information processing system according to an embodiment of the present disclosure will be described hereinafter with reference to the drawings.

### First Embodiment

### Example of System Configuration

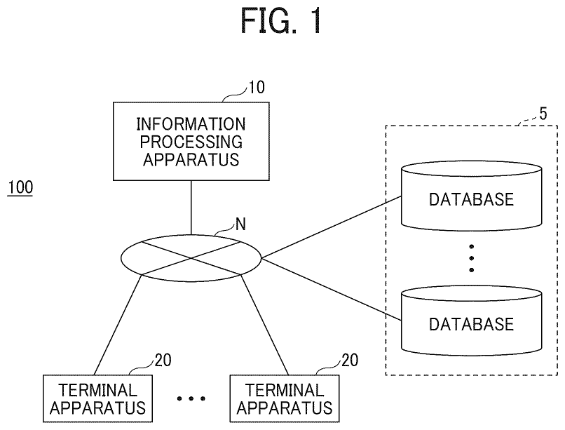

FIG. 1 is a diagram illustrating an example of a configuration of an information processing system 100. In FIG. 1, one or more terminal apparatuses 20 are connected to an information processing apparatus 10 via a network N such as a local area network (LAN) or the Internet.

The information processing apparatus 10 is one or more computers including software (hereinafter referred to as an “agent”) that interacts with a user. The agent is an example of an interactive AI. The interactive AI is an anthropomorphic, virtual existence that appears to the user as a conversation partner. In the conversation with the interactive AI, which is the conversation partner, the user inputs an input message and the interactive AI outputs a response message. In the present embodiment, the agent also displays a list of document data that matches the search of the input message. Specifically, the agent receives an input message input by the user from the terminal apparatus, searches for document data, and generates a response message using the document data. The agent outputs output information including the response message and the list of document data to the terminal apparatus. The input message input by the user may be a question, an instruction, a request, or any other input information to be responded with the response message. The response message is text that includes information corresponding to the input message. The response message may be output by voice.

The agent generates a response message using retrieval augmented generation (RAG). The RAG is a technology of searching for a large number of business documents, regulations, in-house information, external information, and the like accumulated in a storage unit of the company to extract information, and causing a large language model (LLM) to respond based on the extracted information. With the use of the RAG, the information processing apparatus 10 can refer to a database that holds accurate information and generate a response message based on the fact.

While the agent refers to the storage unit in which the document data is stored as described above, it takes time and effort for the user to construct the storage unit for the agent or maintain the storage unit. Thus, there is a demand for synchronizing document data in the database already used by an employee with document data in the storage unit managed by the information processing system 100 and allowing the agent to use the storage unit.

While one database 5 may be provided, as illustrated in FIG. 1, multiple databases 5 may be provided. The database 5 is a mechanism or a system that can efficiently store, manage, search, and update a large amount of data. Thus, the database 5 may be a simple storage or a server. In the present embodiment, document data for business use and the like are stored in the database 5. In one example, a commercial database is known, and the database 5 may be a commercial database. Examples of the commercial database include SharePoint®, BOX, and Dropbox.

In order to access each database 5, an account for each database may be used. This is because when any user can update information of the database 5, it is difficult to ensure accuracy, and it is not desirable in terms of security. Thus, a user who has no account for the database 5 cannot search the database 5. Further, even when the user has the account for the database 5, the user cannot access document data to which the user has no access right.

Even when the user searches for document data (generates a response message) using the agent, security may decrease (for example, information leakage may occur) unless whether the user has the account for the database 5 and the access right to the document data is considered. That is, it is not desirable that the user can access the file when the user uses the agent while the database 5 provides the account management and the access control.

When the user searches for the document data (generates the response message) using the agent, the information processing apparatus 10 determines whether the logged-in user has the account for the database 5 and the access right to the document data. For example, when the user has no access right to the document data that matches the search, the information processing apparatus 10 masks (does not present) the document data. The information processing apparatus 10 does not display the document data in the output information, and does not input, to the AI, the document data to which the user has no access right. For example, when the logged-in user has no account for the database, the information processing apparatus 10 provides an error message to the user.

Accordingly, even when the user having no account for the database 5 or no access right to the document data uses the agent, it is possible to prevent the document data of the database 5 for which the user has no account or the document data of the database 5 to which the user has no access right from being displayed or a response message based on the document data from being generated.

When the database 5 is not present (when a data storage unit 33 to be described below is original storage means), the account for the data storage unit 33 and the access right to the document data are determined. Thus, the database 5 does not have to be present.

The agent is an AI for having conversation with the user (interactive AI). The agent may be referred to as automatic response means, an AI agent, a digital clone, a personalized AI, an AI assistant, an automatic response AI, a conversation partner, an AI chatbot, a companion, a concierge, or a virtual interactive interface. The agent may be a virtual human displayed on the screen of the terminal apparatus 20 as a conversation partner, for example, in the form of a three-dimensional (3D) avatar imitating a person.

The terminal apparatus 20 is an apparatus that functions as a user interface of the information processing system 100. For example, the terminal apparatus 20 may be implemented by a personal computer (PC), a smartphone, or a tablet terminal. The terminal apparatus 20 receives an input message from the user and outputs output information corresponding to the input message. The input message may be, for example, an image, a figure, or voice, instead of text. The output information may include an image, a figure, and voice in addition to the response message.

In the present embodiment, it is assumed that the information processing system 100 operates in a certain company, which may be referred to as a “company X.” The user who can access the information processing apparatus 10 is a person belonging to the company X, such as an employee of the company X. The service provided by the information processing apparatus 10 may be open to the public as a cloud service.

### Terminology

Electronic data is data that can be processed by a computer, and includes data such as text, an image, voice, and a video. In the present embodiment, document data is handled as an example of the electronic data. While the document data refers to an electronically recorded document, the data format thereof is not limited to a specific format. An electronic file (hereinafter, simply referred to as a file) is an example of the document data.

An access right is a right or permission that defines what kind of operation a user or a program can perform on a system or a file. While the access right includes browsing permission, editing permission, deletion permission, and the like, the access right is browsing permission unless otherwise specified in the present embodiment.

An account is a right for a user to log in to a computer or a server. The account may represent authentication information for the account to log in. Login is also referred to as sign-in or logon.

An external database is a database managed by another system that operates independently of the information processing apparatus 10, and is associated with the data storage unit of the information processing apparatus 10.

### Example of Hardware Configuration

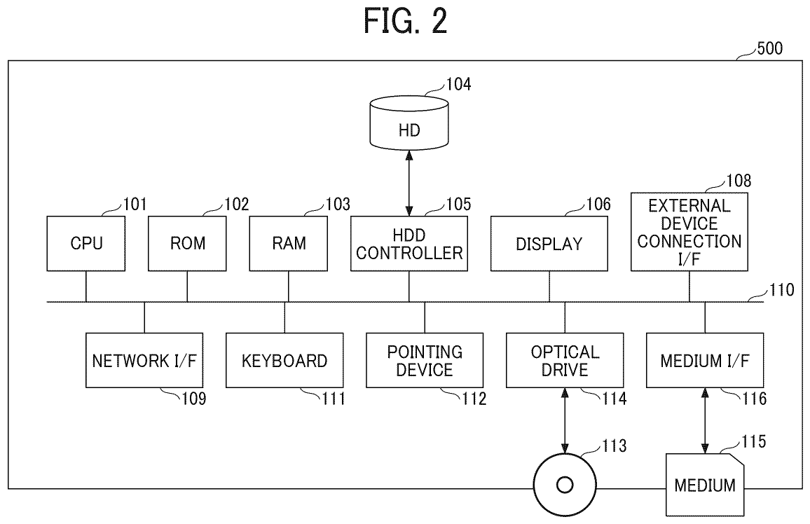

FIG. 2 is a diagram illustrating an example of a hardware configuration of the information processing apparatus 10 and the terminal apparatus 20 according to the present embodiment. As illustrated in FIG. 2, the information processing apparatus 10 and the terminal apparatus 20 are each implemented by a computer 500. The computer 500 includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a bus line 110, a keyboard 111, a pointing device 112, an optical drive 114, and a media I/F 116.

The CPU 101 controls the overall operation of the information processing apparatus 10. The ROM 102 stores, for example, a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108, which may be implemented by an interface circuit, is an interface for connection with various external devices. Examples of the external devices include, but not limited to, a universal serial bus (USB) memory and a printer. The network I/F 109 is an interface circuit that controls communication of data with various external devices through a communication network. The bus line 110 is, for example, an address bus or a data bus that electrically connects the components illustrated in FIG. 2, such as the CPU 101.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The optical drive 114 controls the reading of various data from, or the writing of various data to, an optical storage medium 113, which is an example of a removable storage medium. Examples of the optical storage medium 113 include, but are not limited to, a compact disc (CD), a digital versatile disc (DVD), and a Blu-ray® disc. The media I/F 116 controls the reading of data from, or the writing (storing) of data to (in), a recording medium 115 such as a flash memory.

### Functions

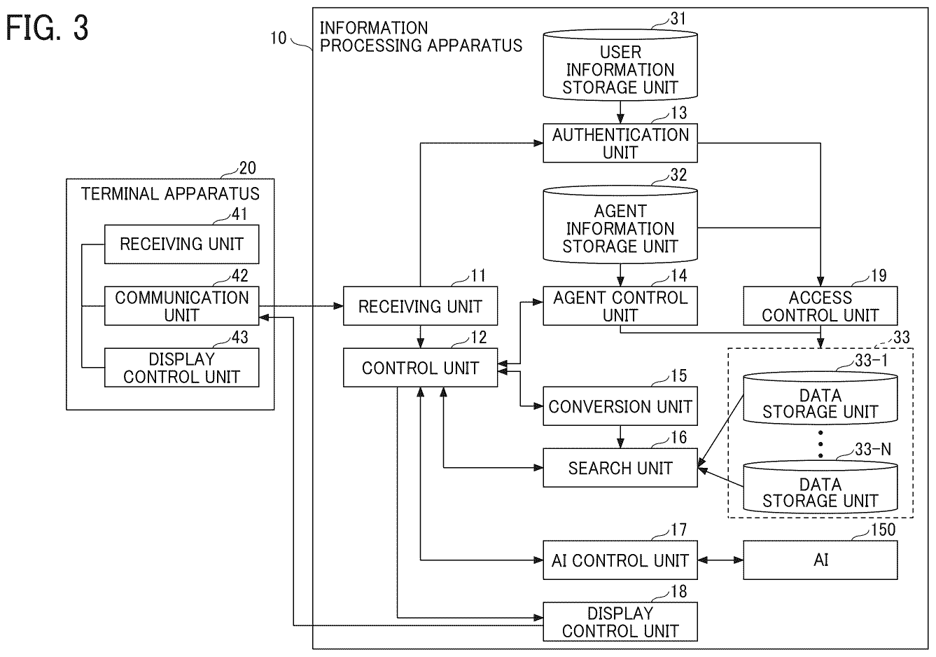

FIG. 3 is a diagram illustrating an example of a functional configuration of the information processing system 100. While the terminal apparatus 20 is illustrated in the information processing system 100 in FIG. 3, the terminal apparatus 20 does not have to be included in the information processing system 100 as long as the terminal apparatus 20 is connected to the network N when the user interacts with the agent.

### Terminal Apparatus 20

The terminal apparatus 20 includes a receiving unit 41, a communication unit 42, and a display control unit 43. These units are implemented by processes that a program installed in the terminal apparatus 20 causes the CPU of the terminal apparatus 20 to perform.

The receiving unit 41 receives an operation performed by the user on the terminal apparatus 20.

The communication unit 42 controls communication with the information processing apparatus 10.

The display control unit 43 controls display of a screen (e.g., an interactive screen 510 described below), based on information (display data) received from the information processing apparatus 10.

The program executed by the terminal apparatus 20 may be a Web application or a native application. The Web application is an application that causes a program on a Web server and a program on a Web browser to perform processing in cooperation with each other, and is an application that is not installed in the terminal apparatus 20. The Web application is downloaded from the information processing apparatus 10. The native application is an application to be installed and used in the terminal apparatus 20.

### Information Processing Apparatus 10

In FIG. 3, the information processing apparatus 10 includes some functional units and some storage units. While FIG. 3 illustrates major functions used for conversation, the information processing apparatus 10 may have functions other than the functions illustrated in FIG. 3. The connection lines between the functional units indicate major connection lines, and information may be transferred between functional units having no connection lines.

The information processing apparatus 10 includes, as functional units, a receiving unit 11, a control unit 12, an authentication unit 13, an agent control unit 14, a conversion unit 15, a search unit 16, an AI control unit 17, a display control unit 18, and an access control unit 19. The information processing apparatus 10 also includes a user information storage unit 31, an agent information storage unit 32, and data storage units 33-1 to 33-N. Hereinafter, a data storage unit is referred to as a “data storage unit 33.”

These units and an AI 150 serving as the functional units of the agent are implemented by the CPU 101 that executes processes according to one or more programs installed in the information processing apparatus 10. The user information storage unit 31, the agent information storage unit 32, and the data storage unit 33 are each implemented by, for example, the HD 104 or a storage device that can be connected to the information processing apparatus 10 via the network.

The AI 150 is a machine learning model that receives an input of text and that is trained to generate text corresponding to the input text. An image, a figure, voice, or the like may be input to the AI 150. While the text input to the AI 150 is referred to as a “prompt,” in the present embodiment, a message input by the user is referred to as an “input message” to be distinguished from a prompt to be described below. The AI 150 generates, for example, text, an image, a figure, or voice as a response message based on the input message. As such an AI 150, for example, a generation AI using a large language model is known. The large language model is a model designed for the natural language processing, which is trained using a large amount of text data. The large language model is input with a large amount of text in advance, and obtains knowledge from the input text, for example, by deep learning or reinforcement learning. The large language model uses this knowledge to provide a response message to an input message. Examples of the input message input to the large language model include text such as an instruction or a question, a file, an image, a figure, voice, and the like. The AI 150 that generates these items of information may be referred to as a generation AI.

The large language model is used in many natural language processing (NLP) tasks, such as generation of a response to a specific question, automatic generation of sentences, summarization of text, translation, and emotion analysis. Further, the large language model can also be used for various applications such as education, entertainment, customer service, and product development. In the present embodiment, text input by the user serves as a main input message. The AI 150 does not have to be operated on the information processing apparatus 10. For example, the AI 150 may be the generation AI that is open to the public, such as the one available on the Internet.

Machine learning is a technology for making a computer acquire human-like learning ability. Machine learning refers to a technology in which a computer autonomously generates an algorithm to be used for a determination such as data identification from training data obtained in advance and applies the generated algorithm to new data to make a prediction. Any suitable learning method is used in machine learning. For example, any one of supervised learning, unsupervised learning, semi-supervised learning, reinforcement learning, and deep learning, or a combination of two or more of those learning methods may be used.

The receiving unit 11 receives an input from the user. For example, the receiving unit 11 receives an input of an input message to the agent, which is the conversation partner. To be exact, the input by the user is performed on the terminal apparatus 20. Thus, the receiving unit 11 receives, from the terminal apparatus 20, the input message received by the terminal apparatus 20.

The control unit 12 controls conversation between the user and the agent. When the receiving unit 11 receives the input message input by the user, the control unit 12 controls the agent control unit 14, the conversion unit 15, the search unit 16, and the AI control unit 17 to create a response message. The control unit 12 controls the display control unit 18 to control the display control unit 18 to cause output information including the response message and the like to be displayed on the terminal apparatus 20.

The conversion unit 15 converts the input message acquired from the control unit 12 into a vector (hereinafter referred to as a “message vector”) that represents the meaning of the input message with a multi-dimensional numerical value. Such a semantic vector is referred to as a distributed representation. The distributed representation is obtained by representing text data with a vector having a fixed length. The conversion into the distributed representation is performed by an existing embedding model. While Bidirectional Encoder Representations from Transformers (BERT®), Document to Vector (Doc2Vec), and the like are known as the embedding model, the input message may be converted into the distributed representation by any method.

When the original text is converted into the distributed representation, the meaning and content of the original text can be represented by numerical values, and comparison using vector data can be performed. In search and comparison using text data of related art, when even one character is different, the text data does not match the search, or when even one character matches the search, the text data matches the search. In contrast, with the comparison using the vector data, information can be searched for based on the degree of similarity in meaning or content of the original text. Since the distributed representation is the vector data, the original text can be represented as a point in a vector space. The degree of similarity of the vector data can be calculated by an existing method such as a cosine similarity.

When the embedding model converts the input message into the distributed representation, since the maximum length of the original text has an upper limit in some cases, the input message may also be divided into chunks to be described below.

The search unit 16 extracts document data having relatively high relevance to the message vector, from among items of document data stored in the data storage unit 33, using the message vector generated by the conversion unit 15. While details will be described later, the document data stored in the data storage unit 33 is divided into chunks in advance, and chunk vectors obtained by converting the chunks into distributed representations are also stored. The chunk that is the source of the chunk vector similar to the message vector is referred to as a “similar chunk.” The search unit 16 acquires the document data that is the source of the similar chunk from the data storage unit 33 as a portion of the search result.

The agent control unit 14 controls switching of an execution agent. The execution agent is an agent that is currently the conversation partner of the user. This is because the agent is prepared for each role (specialized field) to generate a more accurate response message.

When the user selects the execution agent, the agent control unit 14 performs a process of determining the selected agent as the execution agent. When the execution agent is automatically switched in accordance with the progress of the conversation, the control unit 12 determines whether an agent that can output, to the input message received by the receiving unit 11, a response message more appropriate than that of the current execution agent is present among the multiple types of agents. When it is determined that a more appropriate agent is present, the agent control unit 14 executes a process of determining the agent as the execution agent. The process of determining the agent as the execution agent is switching of the prompt and the control rule corresponding to the agent. When the data storage units 33-1 to 33-N to be searched differ from one another depending on the execution agent, the agent control unit 14 designates at least one of the data storage units 33-1 to 33-N corresponding to the execution agent to the search unit 16.

The AI control unit 17 applies the input message received by the receiving unit 11 and the set of similar chunks identified by the search of the search unit 16 to the system prompt to generate a prompt. That is, the AI control unit 17 generates a prompt obtained by expanding the input message received by the receiving unit 11 using the set of similar chunks related to the search result obtained by the search unit 16. A method of adding the set of similar chunks to the prompt may be similar to that of known RAG. Text of each chunk belonging to the set of similar chunks may be added to the prompt, or the chunk vector of the similar chunk may be added to the prompt. A simple example of the system prompt is as follows.
<Example of system prompt begins.>
Input message from user is as follows.
{Message}
Generate response to input message with reference to following documents.
{Set of similar chunks related to search result}
<Example of system prompt ends.>

As described above, the system prompt clearly defines a portion to which the input message is applied and a portion to which the set of similar chunks identified by the search of the search unit 16 is applied. In this case, the AI control unit 17 applies the input message received by the receiving unit 11 to the {message} portion of the system prompt, and applies the set of similar chunks identified by the search of the search unit 16 to the {set of similar chunks related to search result} portion of the system prompt to generate a prompt. By inputting the prompt generated in this manner to the AI 150, the AI 150 can generate a response message by using even the knowledge included in the set of similar chunks, which includes knowledge that the AI 150 has not learned. Accordingly, the response message from the AI 150 may be based on the set of similar chunks related to the search result. The system prompt may include a character string for notifying the AI 150 of the role of the agent corresponding to the system prompt, such as “You are XXX.” (where XXX is a character string indicating the role).

When the control procedure includes multiple phases, a system prompt specifying, for a certain phase, a portion to which an intermediate response obtained in a phase before the certain phase (e.g., an intermediate response obtained in any phase from the first phase to the (K−1)-th phase with respect to the K-th phase) is applied may be defined.

The display control unit 18 transmits the output information to the terminal apparatus 20 to cause various screens for displaying the output information on the terminal apparatus 20 to be displayed on the terminal apparatus 20. The display control unit 18 generates display data and transmits the display data to the terminal apparatus 20. The display control unit 43 of the terminal apparatus 20 performs actual display processing. The display data of the Web application uses, for example, HyperText Markup Language (HTML), Cascading Style Sheets (CSS), JavaScript®, JavaScript Object Notation (JSON), or Extensible Markup Language (XML). The display data of the native application uses, for example, JSON or XML.

The output information includes the response message generated by the AI 150 in response to the input message input by the user and the document data that matches the search. For example, the display control unit 18 causes the response message acquired from the control unit 12, a list of document data included in the search result, and the like to be displayed on the terminal apparatus 20.

The authentication unit 13 authenticates a user who logs in to the information processing apparatus 10 by operating the terminal apparatus 20. The authentication unit 13 authenticates the user based on authentication information (for example, identification information and a password of the user) received by the receiving unit 11. Any existing authentication method such as biometric authentication may be used. Alternatively, the authentication unit 13 may communicate with an external authentication server to authenticate the user.

The access control unit 19 acquires the identification information of the user identified by the authentication of the authentication unit 13 from the authentication unit 13, and excludes, from the search result, document data to which the logged-in user has no access right. While details will be described later, a user having an access right is registered in each document data in the data storage unit 33. The access control unit 19 restricts a search in the data storage unit 33 for which the logged-in user has no account. While details will be described later, a user having an account for the database 5 (the data storage unit 33 synchronized with the database 5) is recorded in the user information storage unit 31.

### Data Storage Unit

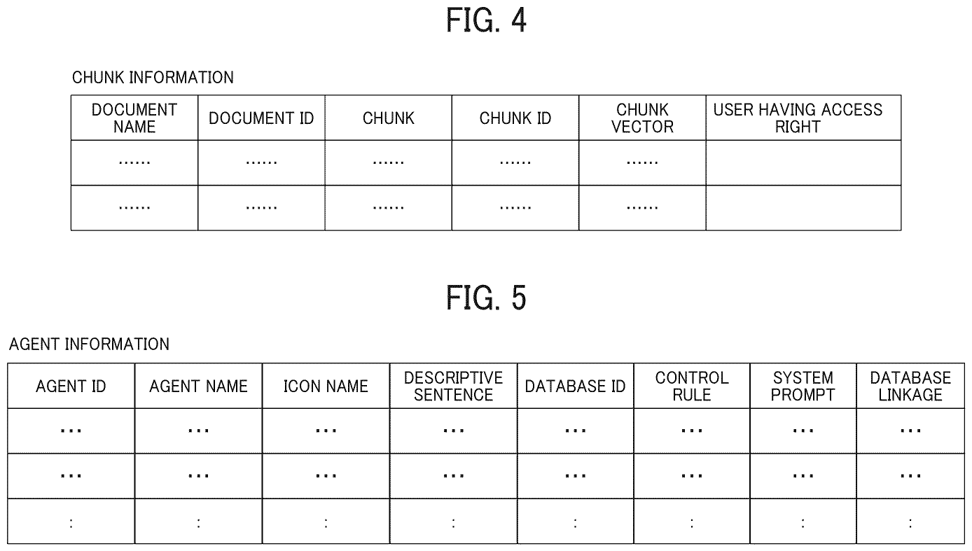

Next, various storage units included in the information processing apparatus 10 will be described with reference to FIG. 4 and the like. FIG. 4 is a table presenting an example of chunk information stored in the data storage unit 33. Document data related to various types of work of the company X is stored (registered) in advance in the data storage units 33-1 to 33-N. The set of document data stored in each of the data storage units 33-1 to 33-N differs. Specifically, the document data to be acquired differs depending on the role of the agent. Accordingly, the data storage units 33-1 to 33-N may be prepared on an agent basis. The document data may be prepared on an agent basis in units of folders in the data storage units 33-1 to 33-N. Some or all of the data storage units 33-1 to 33-N used by two or more agents may be the same.

Each of the data storage units 33-1 to 33-N is synchronized with one of the multiple databases 5. The document data may be synchronized with the data storage units 33-1 to 33-N (registration from the database 5) in a batch, or uploaded to the data storage units 33-1 to 33-N at any timing according to manual operation of the administrator. Alternatively, the user may upload his/her document data. Each of the data storage units 33-1 to 33-N stores, for each document data registered in the data storage unit 33, a document name, a document ID, a chunk, a chunk ID, a chunk vector, and a user who has an access right. The document name is, for example, a file name. The document ID is identification information of the document data.

The chunk of the document data refers to a portion of the document data obtained by dividing the document data in predetermined units. The dividing unit of the document data may be defined by the number of characters, the number of sentences, or a semantic unit (for example, a paragraph). The chunks of the document data may be stored in advance after the document data is divided in units. A semantic vector obtained by converting each chunk into a distributed representation is a chunk vector.

The document data is data acquired by the agent from the external database 5 and stored in the data storage unit 33 or data manually uploaded by the user. A user having an account used when the agent acquires the document data is “a user having an access right” to the document data. Since the access right to the document data is set when the document data is registered in the external database 5, the user who originally has the access right is also “the user having an access right.” For document data acquired by the agent from the database with special permission, the access right may be set for all users.

The search unit 16 calculates, for each document data in the data storage units 33-1 to 33-N to be searched, the degree of similarity between the message vector and the chunk vector of the document data. The search unit 16 identifies a chunk corresponding to a chunk vector having a certain degree of similarity or higher for the document data. This chunk is a similar chunk. The search unit 16 compares the degrees of similarity of the similar chunks and extracts the top M similar chunks having the highest degrees of similarity. Multiple similar chunks may be found for one document data, and hence N (<M) items of document data are substantially extracted. The search unit 16 identifies similar chunks such that N is a predetermined number. To evaluate the similarity between the vectors, a cosine similarity may be used, or another index may be used.

The search unit 16 adds information (hereinafter referred to as “related document information”) including the top M similar chunks, chunk IDs stored in the data storage unit 33 in association with the similar chunks, document IDs of the N items of document data that are the sources of the similar chunks, and document names to the search result. The related document information may include document data. Each data storage unit 33 may be managed based on a folder, a database, or any other management unit of the set of document data.

### Agent Information Storage Unit

FIG. 5 is a table presenting an example of agent information stored in the agent information storage unit 32. As presented in FIG. 5, the agent information storage unit 32 stores in advance an agent ID, an agent name, an icon name, a descriptive sentence, a database ID, a control rule, a system prompt, database linkage, and the like for each agent registered in the information processing apparatus 10.

The agent ID is identification information of an agent.

The agent name is the name of the agent.

The icon name is the file name of an icon representing the agent. The icon is displayed on a screen (interactive screen) for conversation between the user and the agent.

The descriptive sentence is text data describing, for example, the role of the agent in natural language.

The database ID is identification information of the database 5 associated with the agent. Two or more databases 5 may be search targets.

The control rule and the system prompt are a control rule and a system prompt for causing the AI control unit 17 to correspond to the agent. Since the control rule and the system prompt are defined for each agent, multiple different types of control rules and system prompts are prepared in advance. Even when multiple agents search the same database, by using different control rules for the multiple agents, the agents can obtain different response messages from the AI 150. That is, the role of the agent is implemented by the control rule and the system prompt. For example, when the agent has a role of outputting an inquiry answer for generating a response message in response to an input message (question) input by the user, a descriptive sentence for describing such a role, and a control rule and a system prompt for controlling the agent in such a manner are stored in association with the agent. When the agent has a role of analyzing data in response to an instruction from the user and outputting an analysis result, a descriptive sentence describing such a role, and a control rule and a system prompt for controlling the agent in such a manner are stored in association with the agent.

The system prompt is a template (form) of a prompt that is prepared in advance for each agent (each role) and that is input to the AI 150. For example, an input message received by the receiving unit 11 is applied to a system template to generate a prompt to be input to the AI 150.

The control rule is data that defines a procedure for input/output (interaction) of the AI 150 and is prepared in advance for each agent (each role). In order to obtain a response to an input message input by the user according to the role of the execution agent, it is not sufficient to input a prompt to the AI 150 once, and it may be desirable to cause the AI 150 to perform, for example, multiple tasks such as extraction and classification of specific information, prediction, and loop processing. In this case, a prompt is to be input for each task. The control rule is data that defines information indicating which prompts are to be input to the AI 150 and in which order the prompts are to be input to the AI 150 (i.e., a procedure of interaction with the AI 150). The interaction with the AI 150 based on one control rule is hereinafter referred to as a “control procedure,” and one input of a prompt to the AI 150 in the control procedure is referred to as a “phase.” When the control procedure includes multiple phases, a system prompt corresponding to each phase is prepared. In this case, to the system prompt of a certain phase, an input message received by the receiving unit 11 may be applied. To the system prompt of another phase, a response obtained before the phase in the control procedure may be applied. To distinguish a response message obtained from the AI 150 in the middle of the control procedure from a response message finally obtained from the AI 150 in the control procedure (i.e., a response message to an input message from the user), the former is referred to as an “intermediate response message” and the latter is referred to as a “final response message.” When a prompt is to be input once in the control procedure, the control rule includes one phase, and the number of system prompts is one. In this case, there is no intermediate response message, and the final response message is obtained in response to one input of the prompt.

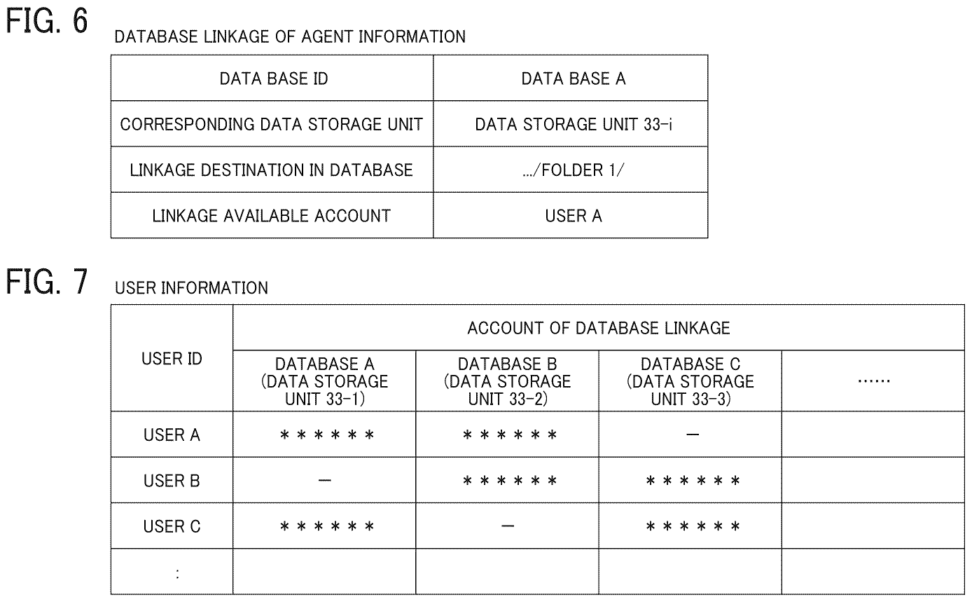

The database linkage is information related to the database 5 associated with the agent. When the agent is associated, the data storage unit 33 used by the agent for search is synchronized with an external database. In the item of database linkage, information for database linkage is registered. The description is continued with reference to FIG. 6.

FIG. 6 is a table presenting items of database linkage included in the agent information.

The database ID represents identification information of the database 5 associated with the agent.

The corresponding data storage unit represents identification information of the data storage unit 33 synchronized with the database 5 in the information processing apparatus 10.

The linkage destination in the data storage unit 33 represents a folder, a directory, or a workspace of document data constructed in the database 5. That is, the agent synchronizes document data in a folder of the linkage destination in a database A identified using the database ID with a data storage unit 33-i. When the document data is files, the document data may be further subdivided and a linkage destination may be registered in units of files.

The database linkage available account represents a user having an account for the linkage destination in the database 5. The user can at least browse document data in the linkage destination in the database 5. The user may further have permission to register, edit, and delete document data. Since the account of a “user A” is registered in FIG. 6, document data that can be acquired using the account of the “user A” is stored in the data storage unit 33-i from the database A. As a matter of course, the user A has an access right to the acquired document data. The document data acquired using the account of the user A may include document data to which the user B originally has an access right.

### User Information Storage Unit

FIG. 7 is a table presenting an example of user information stored in the user information storage unit 31. FIG. 7 presents information related to an account for a database in the user information. In the user information, an account for each database is registered in association with a user ID. The account is information for accessing a database, such as a user ID and a password or an authentication token. The user for which “*******” is set in the user information has an account for the database.

Databases A to C and the like are, for example, various databases 5 used in the company X, such as a personnel database, a customer database, a sales database, a product database, a business card database, a stock database, and an expense database. The databases A to C and the like correspond to the data storage units 33-1 to 33-N. While the correspondence means synchronization, the document data in the database 5 does not have to be completely the same as the document data in the data storage unit 33. The database 5 and the data storage unit 33 may be implemented by one entity.

### Operations and Processes

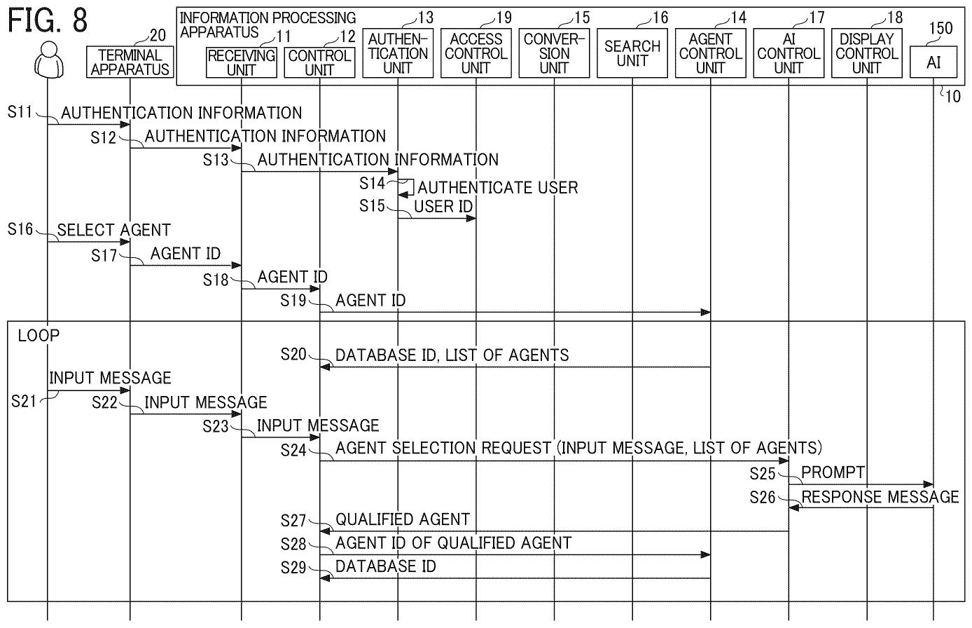

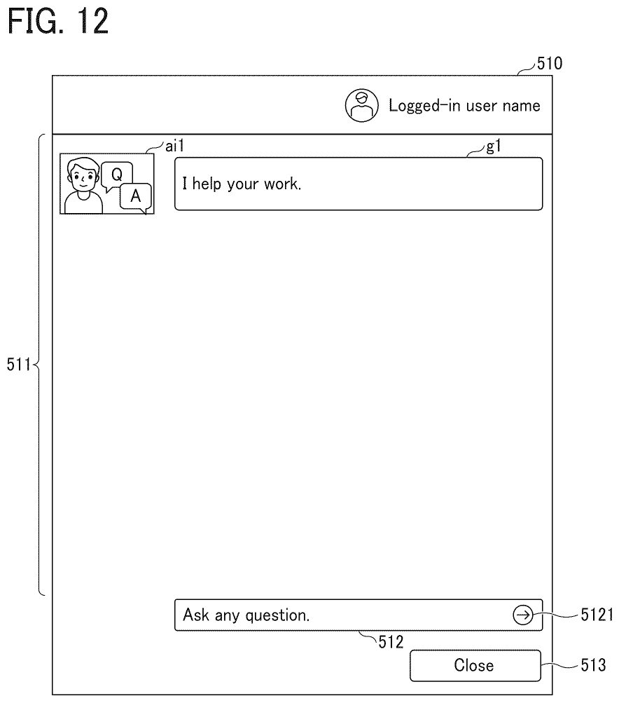

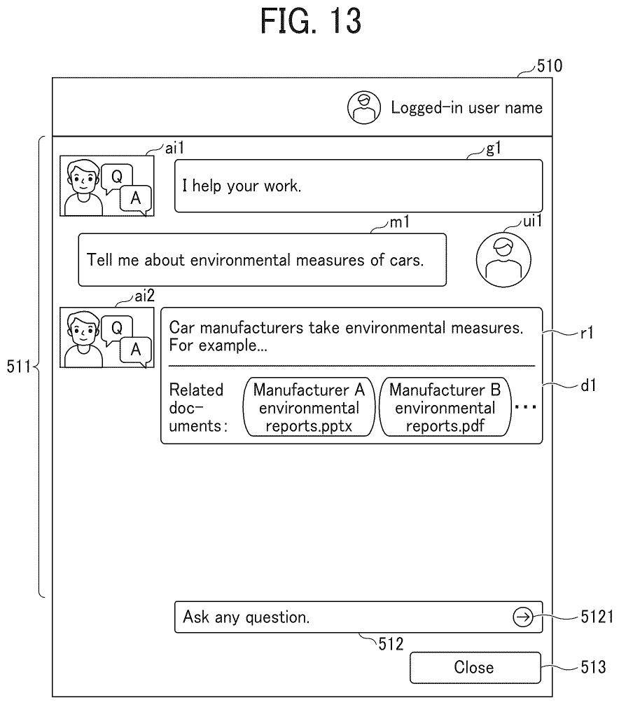

Referring to FIG. 8, operations and processes performed by the information processing system 100 will be described. FIG. 8 is a sequence diagram presenting an example of operations and processes performed by the information processing system 100.
S11: A user who wants to make an inquiry to an agent logs in to the information processing apparatus 10. The user inputs authentication information to the terminal apparatus 20, and the receiving unit 41 receives the input of the authentication information.
S12: The communication unit 42 transmits an authentication request together with the authentication information to the information processing apparatus 10.
S13: When receiving the authentication information, the receiving unit 11 of the information processing apparatus 10 transmits the authentication information to the authentication unit 13.
S14: The authentication unit 13 authenticates the user based on the authentication information. It is assumed that the authentication is successful. When the authentication is successful, the user ID is identified.
S15: The authentication unit 13 transmits the user ID of the logged-in user to the access control unit 19 for control of an access to document data to be performed later. The authentication unit 13 transmits the successful authentication to the control unit 12 via the receiving unit 11.
S16: With the successful authentication, the terminal apparatus 20 displays an execution agent selection screen. On the execution agent selection screen, a list of selectable agents is displayed. When the user selects one of the agents displayed on the execution agent selection screen, the receiving unit 41 of the terminal apparatus 20 receives the selection.
S17: The communication unit 42 transmits identification information (hereinafter referred to as an “agent ID”) of the selected agent to the information processing apparatus 10.
S18: When receiving the agent ID, the receiving unit 11 of the information processing apparatus 10 transmits the agent ID to the control unit 12.
S19: The control unit 12 transmits the agent ID to the agent control unit 14. The transmission of the agent ID is to notify the agent control unit 14 of an execution agent. More specifically, a qualified agent may be the execution agent.
S20: The agent control unit 14 acquires agent information corresponding to the transmitted agent ID from the agent information storage unit 32. The agent control unit 14 returns a database ID associated with the agent ID acquired from the agent information storage unit 32 and a list of agents to the control unit 12. The list of agents is a list of agents stored in the agent information storage unit 32. The list of agents is returned to select an appropriate agent for an input message input by the user. In addition, the agent control unit 14 sets a control rule and a system prompt of the agent information in the AI control unit 17 via the control unit 12.
S21: The user inputs an input message to a message input area of an interactive screen and clicks a send icon 5121 (see FIG. 12). The receiving unit 41 of the terminal apparatus 20 receives these operations.
S22: The communication unit 42 of the terminal apparatus 20 transmits the input message to the information processing apparatus 10.
S23: When receiving the input message, the receiving unit 11 of the information processing apparatus 10 transmits the input message to the control unit 12.
S24: When receiving the input message, the control unit 12 transmits an agent selection request to the AI control unit 17. The agent selection request includes the input message and the list of agents. The selection request means a selection request for an agent qualified to generate a response message in response to the input message. Being qualified to generate a response message represents that the most appropriate response message can be output in response to the input message.
S25: The AI control unit 17 generates a prompt to instruct the AI 150 to select a qualified agent based on the input message, the list of agents, and a system prompt prepared in advance for selection of a qualified agent, and transmits the prompt to the AI 150. The prompt generated at this time is a prompt for requesting selection of an agent having a role that can generate an appropriate response message in response to the input message from the user from among multiple agents having different roles. In other words, the prompt causes an AI to determine a type of a response message requested by the user based on the input message input by the user and causes the AI to determine an agent that can generate a response message of the type, based on the role of each agent.

A simple example of the system prompt is as follows.
<Example of system prompt begins.>
Input message from user is as follows.
{Message}
Candidates for agent that responds to input message described above are as follows.
{List of agent IDs and agent descriptive sentences}
Select, from among agents described above, agent that can output most appropriate response to input message described above, and output agent ID of that agent.
<Example of system prompt ends.>

In this case, the AI control unit 17 applies the input message to the {message} portion of the system prompt, and applies, for each agent, the agent ID and the descriptive sentence of the agent (i.e., the role of the agent) to the {list of agent IDs and agent descriptive sentences} portion of the system prompt to generate a prompt.
S26: The AI 150 which has received the input of the prompt generated as described above selects a qualified agent from among the agents listed in the prompt based on the trained parameters, and generates a response message including the ID of the selected agent. The AI 150 transmits the response message to the AI control unit 17. The AI control unit 17 receives the response message from the AI 150. The response message is the agent ID of the agent selected as the qualified agent.
S27: The AI control unit 17 transmits the agent ID of the qualified agent to the control unit 12. The agent instructed by the user or the qualified agent is the execution agent. While the agent is automatically switched in the sequence diagram of FIG. 8, when the user does not desire automatic switching of the agent, the execution agent may be fixed. As the method of fixing the execution agent, the user may instruct the fixing in an input message, or the user may set the fixing using a button on the interactive screen.
S28: The control unit 12 transmits the agent ID of the qualified agent to the agent control unit 14. The agent control unit 14 compares the agent ID of the qualified agent output by the AI control unit 17 with the agent ID selected by the user, and when the agent IDs are the same, the agent control unit 14 proceeds to a process of responding to the input message. When the agent IDs are different, the agent control unit 14 performs again the same process (setting the control rule and the system prompt of the agent information, in the AI control unit 17 via the control unit 12) as when the agent control unit 14 receives the agent ID in step S19.
S29: The agent control unit 14 returns a database ID acquired from the agent information storage unit 32 and associated with the agent ID to the control unit 12.

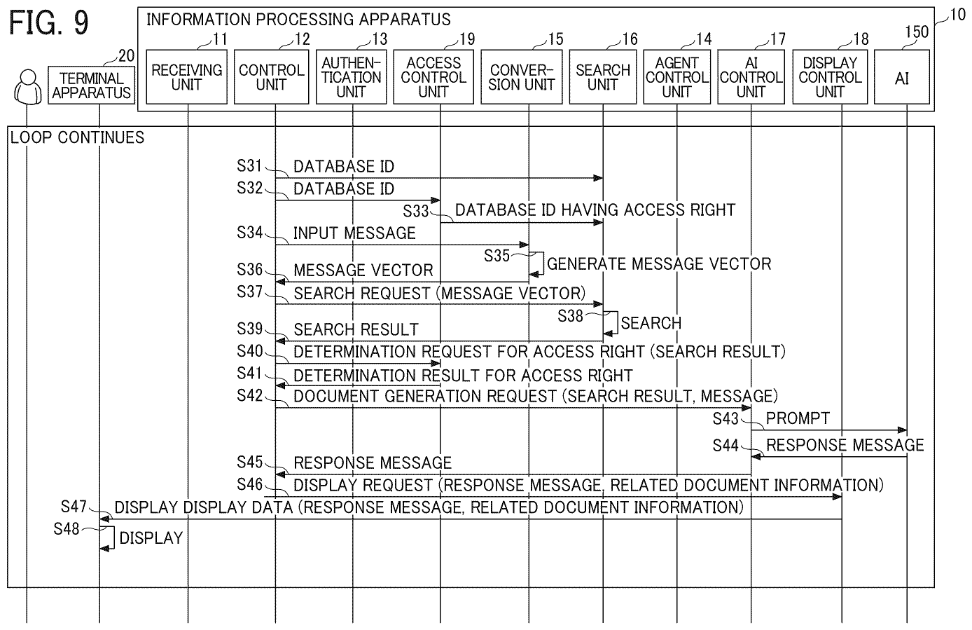

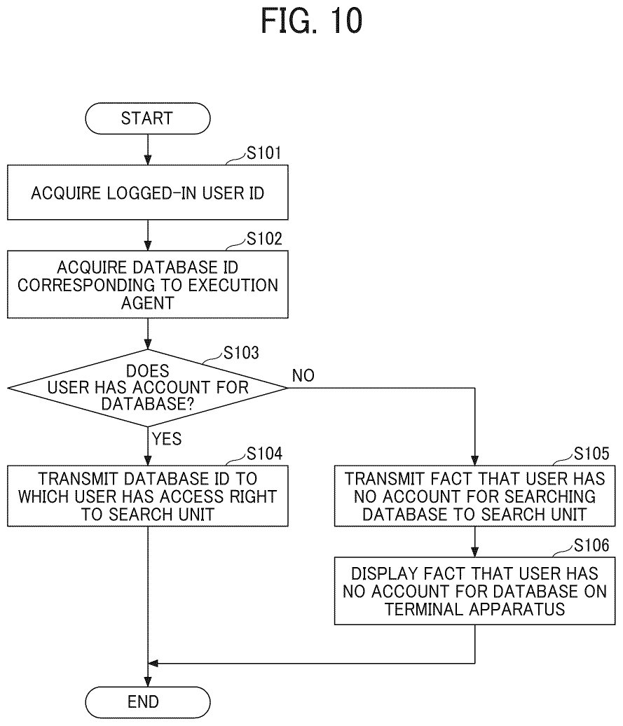

FIG. 9 is a sequence diagram presenting an example of operations and processes performed by the information processing system 100 for the process of responding to the input message.
S31: The control unit 12 transmits the database ID acquired from the agent control unit 14 to the search unit 16. As a result, the search unit 16 sets the data storage unit 33 corresponding to the execution agent (the data storage unit 33 synchronized with the database 5 identified using the database ID) as a search target.
S32: The control unit 12 transmits the database ID acquired from the agent control unit 14 to the access control unit 19 for access control.
S33: The access control unit 19 determines whether the logged-in user has an account for accessing the data storage unit 33 based on the database ID and the user ID. Details of the determination will be described with reference to FIG. 10. The access control unit 19 transmits the database ID of the database for which the user has an account to the search unit 16. As a result, the search unit 16 sets, as the search target, the data storage unit 33 that corresponds to the execution agent and that is synchronized with the database for which the logged-in user has the account.

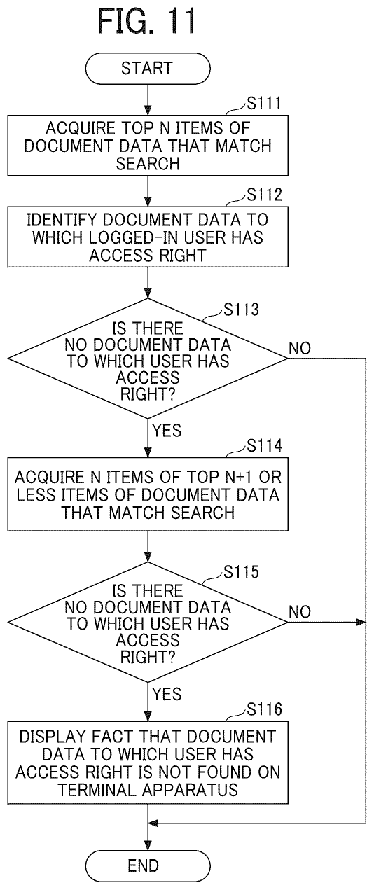

When the user has no account for the data storage unit 33 corresponding to the execution agent, the access control unit 19 transmits, to the search unit 16, the fact that the user has no account for the database 5 synchronized with the data storage unit 33. In this case, the search unit 16 does not perform a search even when receiving a message vector converted from an input message.
S34: The control unit 12 transmits the input message input by the user to the conversion unit 15.
S35: The conversion unit 15 converts the input message into a message vector.
S36: The conversion unit 15 returns the message vector to the control unit 12.
S37: The control unit 12 transmits a search request together with the message vector to the search unit 16.
S38: The search unit 16 identifies the database 5 using the database ID transmitted in step S33, identifies the data storage unit 33 synchronized with the database 5, and searches for a chunk vector stored in the data storage unit 33 using the message vector. The search unit 16 identifies a chunk vector having a relatively high similarity to the message vector and extracts a similar chunk that is the source of the chunk vector. For example, similar chunks that are the sources of chunk vectors up to the top M-th highest degree of similarity between the message vector and the chunk vectors are extracted. The search unit 16 generates a search result including related document information (top M similar chunks, chunk IDs corresponding to the similar chunks, and document IDs and document names of N items of document data that are the sources of the similar chunks). This document data may be referred to as “document data that matches search.”
S39: The search unit 16 transmits the search result to the control unit 12.
S40: The control unit 12 transmits a determination request for an access right together with the acquired search result to the access control unit 19.
S41: The access control unit 19 compares “the user having the access right” to the document data included in the search result with the logged-in user to identify document data to which the logged-in user has an access right. Details of this process will be described with reference to FIG. 11. The access control unit 19 attaches the presence or absence of an access right of the user to each document data and returns the document data to the control unit 12.
S42: The control unit 12 transmits a document generation request to the AI control unit 17 together with the search result (the similar chunks, and the document IDs and the document names of the N items of document data that are the sources of the similar chunks) related to the document data to which the user has the access right and the input message.
S43: The AI control unit 17 generates a prompt based on the received search result and input message, and the control rule and the system prompt. The AI control unit 17 transmits the prompt to the AI 150.
S44: The AI control unit 17 receives, from the AI 150, a response message generated by the AI 150 to which the prompt has been input. Depending on the control procedure, the first response is not the final response, and the final response message is obtained by repeating steps S43 and S44 multiple times.
S45: The AI control unit 17 transmits the generated response message to the control unit 12.
S46: The control unit 12 transmits, to the display control unit 18, a display request for output information including the response message and the related document information (the document ID and the document name of the document data to which the user has the access right) included in the search result.
S47: The display control unit 18 causes the output information to be displayed on the interactive screen displayed on the terminal apparatus 20. Specifically, the display control unit 18 generates display data for causing the output information to be displayed, and transmits the generated display data to the terminal apparatus 20 to cause the output information to be displayed on the interactive screen 510.
S48: The communication unit 42 of the terminal apparatus 20 receives the display data, and the display control unit 43 causes the output information to be displayed (see FIG. 13).

FIG. 10 is a flowchart presenting details of the process performed by the access control unit 19 in step S32 in FIG. 9.

The access control unit 19 acquires the user ID of the logged-in user from the authentication unit 13 (S101).

The access control unit 19 acquires the database ID corresponding to the execution agent from the control unit 12 (S102). The execution agent may be one selected by the user or a qualified agent determined based on the input message.

Then, the access control unit 19 determines whether the user has an account for the database (S103). When “*******” is set in the cell at the intersection of the database ID and the user ID in the user information presented in FIG. 7, the access control unit 19 determines that the logged-in user has an account for the database.

When the determination in step S103 is Yes, the access control unit 19 transmits the database ID for which the user has the account to the search unit 16 (S104).

When the determination in step S103 is No, the access control unit 19 transmits the fact that the logged-in user has no account for searching the database to the search unit 16 (S105).

The display control unit 18 causes the fact (error message) that the logged-in user has no account for the database 5 associated with the execution agent to be displayed on the terminal apparatus 20 (S106).

Accordingly, before the search unit 16 performs a search, the user can be notified of the fact that the user has no account for the database 5. In other words, a situation in which there is no document data to which the user has an access right among the items of document data that match the search performed by the search unit 16 can be avoided before the search.

FIG. 11 is a flowchart presenting details of the process performed by the access control unit 19 in step S41 in FIG. 9.

The access control unit 19 acquires the document IDs of the top N items of document data that match the search (S111).

Based on whether the user having the access right to the document data that matches the search is the same as the logged-in user, the access control unit 19 identifies document data to which the logged-in user has an access right (S112).

The access control unit 19 determines whether there is no document data to which the user has an access right (S113).

When the determination in step S113 is No (when there is document data to which the user has an access right), the control unit 12 proceeds with the process for a response message using the document data to which the user has the access right. The number of items of document data to which the user has access rights may be less than N, or the control unit 12 may adjust the number of items of document data to N.

When the determination in step S113 is Yes (when there is no document data to which the user has an access right), the access control unit 19 acquires document IDs of N items of top N+1 or less items of document data that match the search (S114).

The access control unit 19 determines whether there is no document data to which the user has an access right (S115). Accordingly, a situation in which there is no document data to which the user has an access right can be prevented from occurring. The process when the determination in step S115 is No (when there is document data to which the user has an access right) may be the same as the process when the determination in step S113 is No.

When the determination in step S115 is Yes (when there is no document data to which the user has an access right), the access control unit 19 causes the fact (error message) that document data to which the user has an access right is not found to be displayed on the terminal apparatus 20 via the control unit 12 (S116).

When the determination in step S113 is Yes, the control unit 12 may cause the fact (error message) that document data to which the user has an access right is not found to be displayed on the terminal apparatus 20, without determining whether the user has access rights to the N items of the top N+1 or less items of document data in step S115.

### Examples of Screen of Terminal Apparatus

Next, examples of a screen displayed by the terminal apparatus 20 will be described with reference to FIG. 12 and the like. FIG. 12 is a view illustrating an example of display of an interactive screen 510 at the start of conversation. The interactive screen 510 includes an interactive display area 511, a message input area 512, and a button 513. The interactive display area 511 is an area in which the content of the conversation between the agent and the user is displayed. In the initial state, the interactive display area 511 displays an introductory sentence g1 (“I help your work.”) prompting the user to input an input message. An icon ai1 representing the execution agent is displayed on the left of the introductory sentence g1. The icon ai1 is an image stored in a file related to the icon name of the agent information. The icon ai1 allows the user to visually recognize the agent of the current conversation partner (i.e., execution agent). The message input area 512 is an area for receiving an input of an input message from the user, and includes a send icon 5121. The button 513 is a button for receiving an instruction to end the conversation.

FIG. 13 is a view illustrating an example of display of output information. In the description of FIG. 13, the same portions as those in FIG. 12 are denoted by the same reference numerals, and the description thereof will be omitted. In the interactive screen 510 illustrated in FIG. 13, an input message m1, a response message r1, and related document information d1 are added. The response message r1 and the related document information d1 are output information.

The input message m1 is an input message that the user has input in the message input area 512 in step S21 in FIG. 8. When the user clicks the send icon 5121, the input message input in the message input area 512 is displayed in the interactive display area 511.

The response message r1 is a response message generated by the AI 150. The related document information d1 is document data that matches the input message in the data storage unit 33 searched by the agent. FIG. 13 illustrates an example in which a list of document names included in the related document information is displayed as the related document information d1. The display format of the list of document names is an example, and the list of document names may be divided in multiple balloons and output.

In FIG. 13, an icon ui1 is added on the right of the input message m1, and an icon ai2 is added on the left of the response message r1. The icon ui1 is an icon of the user. The icon ai2 is an icon of the execution agent that has responded. Since the agent is not switched, the icon ai2 is the same as the icon ai1.

The user may continue the conversation or may end the conversation. To end the conversation, the user clicks the button 513. In this case, the session ends, and the procedure presented in FIG. 9 ends. To continue the conversation, the user inputs a new input message in the message input area 512 and clicks the send icon 5121. In this case, the input message is transmitted to the information processing apparatus 10, and step S21 and the subsequent steps are repeated.

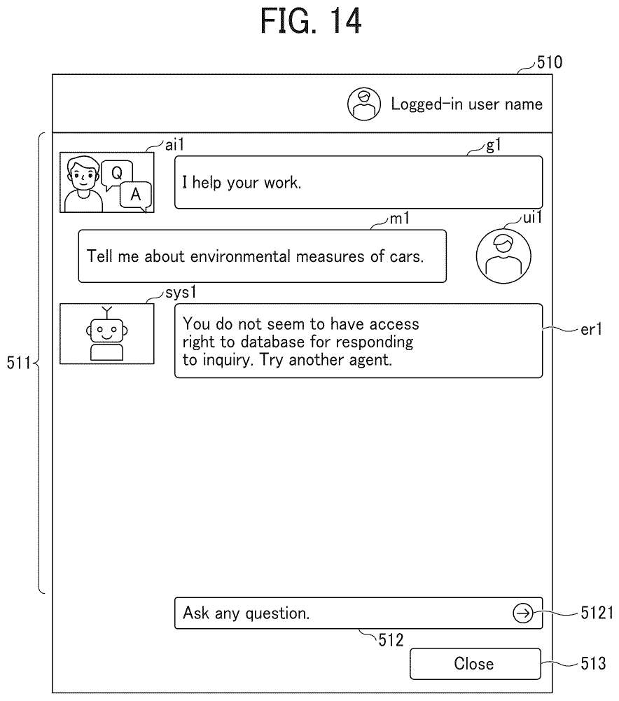

FIG. 14 is a view illustrating an error message er1 displayed on the terminal apparatus 20 when the user has no account for the database 5. In the description of FIG. 14, the same portions as those in FIG. 12 are denoted by the same reference numerals, and the description thereof will be omitted. The input message m1 is an input message that the user has input in the message input area 512 in step S21. While the qualified agent is determined based on the input message m1, the user has no account for the database 5 associated with the agent. Thus, the display control unit 43 causes an icon sys1 and an error message er1 to be displayed. The icon sys1 is an icon indicating the information processing apparatus 10. Since the icon ai1 has been switched to the icon sys1, the user can recognize that the system gives a response instead of the execution agent.

The error message er1 is, for example, “You do not seem to have access right to database for responding to inquiry. Try another agent.” The user can recognize that the user has no account for the database 5 that stores document data to be used by the user. The user can request the execution agent to display a list of databases for which the user has accounts and a list of agents associated with the databases. Alternatively, the display control unit 18 may cause a list of databases and agents associated with the databases to be displayed together with the error message er1. The user can designate an agent associated with the database 5 to be searched. In this case, the user preferably requests the information processing apparatus 10 not to change the execution agent (to fix the execution agent) in an input message.

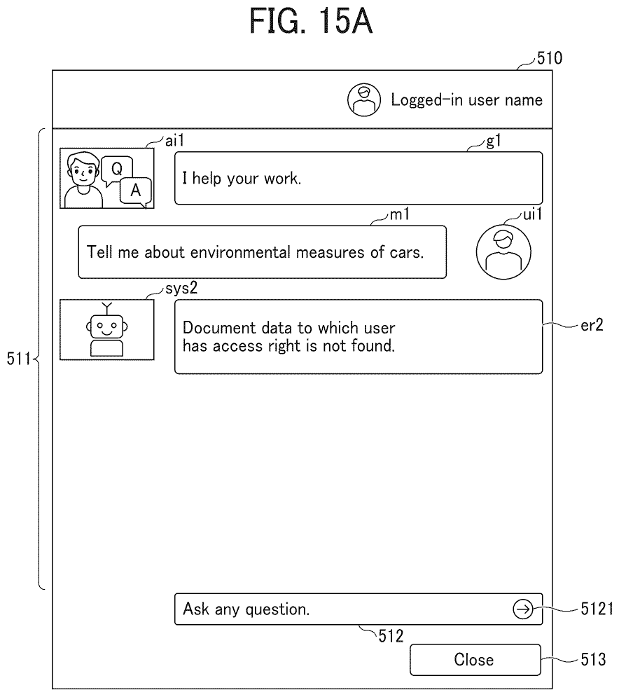

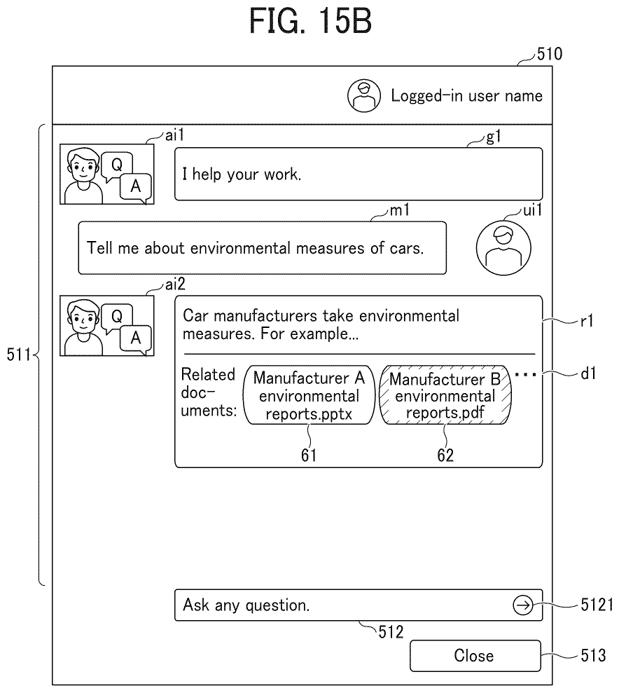

FIG. 15A is a view illustrating an error message displayed on the terminal apparatus 20 when document data to which the user has an access right is not found although the data storage unit 33 is searched. In the description of FIG. 15A, the same portions as those in FIG. 14 are denoted by the same reference numerals, and the description thereof will be omitted. While the data storage unit 33 is searched based on the input message m1 and the N items of document data are identified, document data to which the user has an access right is not found. Thus, the display control unit 43 causes an icon sys2 and an error message er2 to be displayed. The icon sys2 is an icon indicating the information processing apparatus 10. Since the icon ai1 is switched to the icon sys2, the user can recognize that the system gives a response instead of the execution agent.

The error message er2 is, for example, “Document data to which user has access right is not found.” The user can recognize that, although the user has the account for the database 5 that stores the document data to be used by the user, the user has no access right to the document. The user may input an input message different from the input message m1 to the message input area 512.

FIG. 15B is a view illustrating an example of display of document data that matches the search and document data that does not match the search in the data storage unit 33. In FIG. 15B, the user has an access right to document data 61 and has no access right to document data 62 among items of document data that match the search. The display control unit 43 of the terminal apparatus 20 displays the document data 62 to which the user has no access right, in a manner in which the user cannot press the document data 62 (for example, grayed out, reduced in brightness, or added with a strike-through line). Even when the user presses the document data 62, the terminal apparatus 20 does not receive the operation.

Accordingly, the user can recognize to which document data the user has an access right or to which document data the user has no access right. The user can recognize whether there is no document data that matches the search or there is document data that matches the search but the user has no access right to the document data. For example, even in FIG. 15A, the display control unit 43 may display all items of document data that match the search in a manner in which the document data cannot be pressed.

### Association between Database and Data Storage Unit

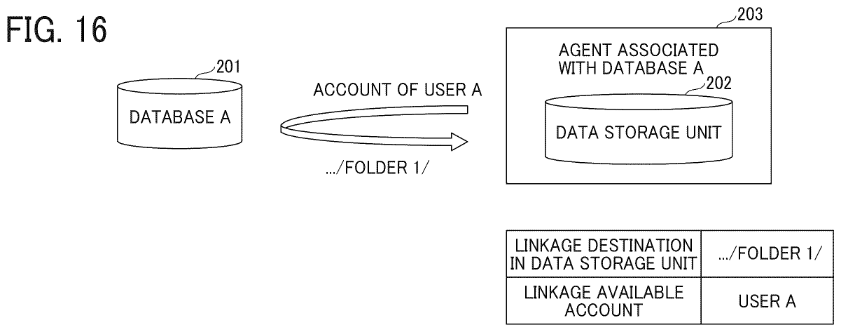

Next, referring to FIG. 16 and the like, association between the database 5 and the data storage unit 33 will be described. FIG. 16 is a conceptual diagram illustrating a process in which an agent 203 acquires document data from a database 201. In FIG. 16, the database 201 is externally present, and the agent 203 associated with the database 201 is present. Thus, the agent 203 searches a data storage unit 202.

With the setting of database linkage of the agent 203, association with a folder 1 of the database 201 is set. An account that can be associated with the folder 1 of the database 201 is an account of a user A.

The agent 203 synchronizes document data in the data storage unit 202 with document data in the database 201 at a predetermined timing such as batch processing. The predetermined timing may be a fixed time, when the load decreases, when the database A is updated, when the user manually gives an instruction. The agent 203 accesses the folder 1 of the database 201 using the account of the user A to acquire updated document data, and stores the document data in the data storage unit 202. Accordingly, the document data that can be acquired using the account of the user A among items of document data held in the external database 201 can be stored in the data storage unit 202. In other words, the agent 203 can synchronize the data storage unit 202 with the folder 1 of the database 201.

While the agent 203 synchronizes the document data using the account of the user A in FIG. 16, the user A may register, in the data storage unit 202, document data created by the user A and locally held. In this case, at least the fact that the user A has the access right is also registered.

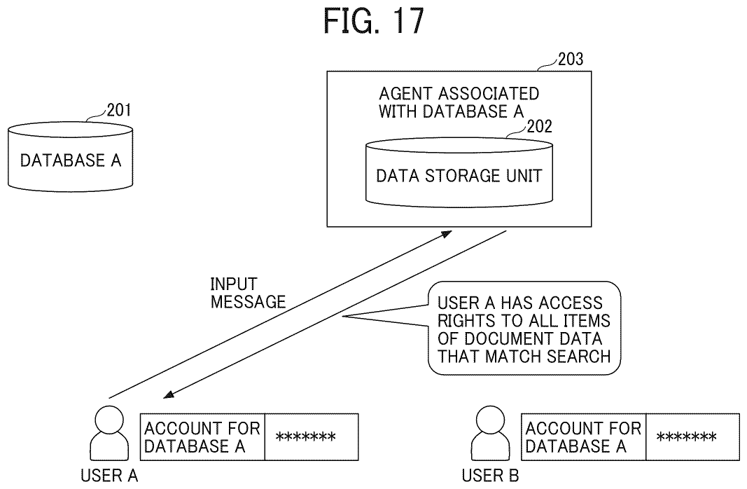

FIG. 17 is a conceptual diagram illustrating a process in which the user A uses the agent 203 to display a response message. FIG. 17 illustrates a search phase. When the user A transmits an input message to the information processing apparatus 10, the search unit 16 searches the data storage unit 202 and acquires document data associated with a chunk vector similar to a message vector. Since the access control unit 19 determines whether the user A has an access right to document data included in the search result, the control unit 12 transmits document data to which the user A has an access right to the AI 150.

In the description of FIG. 16, since the document data is synchronized using the account of the user A (first user), the user A basically has access rights to all items of document data that match the search.

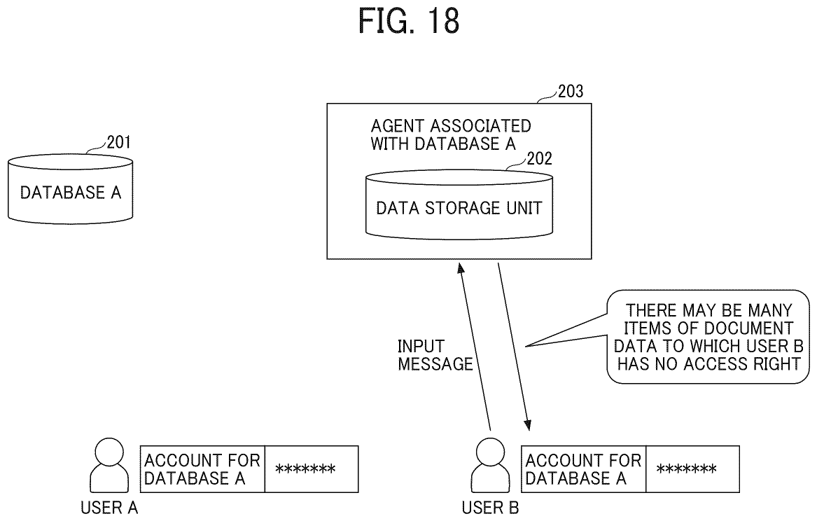

FIG. 18 is a conceptual diagram illustrating a process in which a user B uses the agent 203 to display a response message. FIG. 18 illustrates a search phase. When the user B transmits an input message to the information processing apparatus 10, the search unit 16 searches the data storage unit 202 and acquires document data having a chunk vector similar to a message vector. Since the access control unit 19 determines whether the user B has an access right to document data included in the search result, the control unit 12 transmits document data to which the user B has an access right to the AI 150.

In the description of FIG. 16, since the document data is synchronized using the account of the user A, there may be many items of document data to which the user B (second user) has no access right. When there is no document data for which the user B has permission, the information processing apparatus 10 causes an error message indicating that there is no access right to the file to be displayed on the terminal apparatus 20.

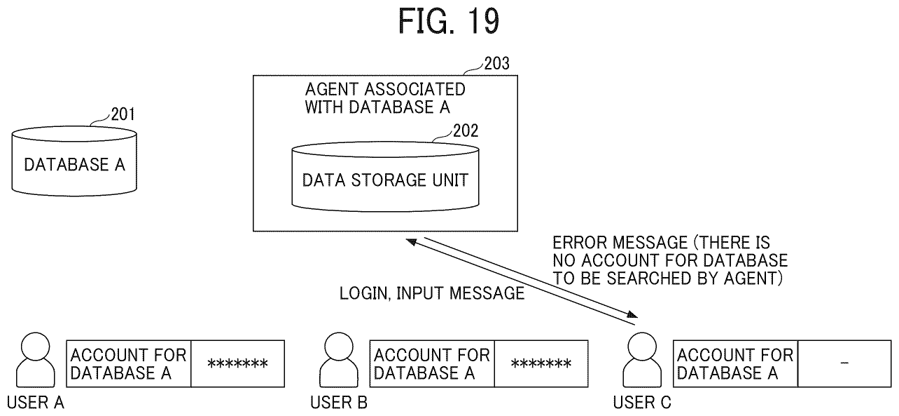

FIG. 19 is a conceptual diagram illustrating a process in which a user C uses the agent to display a response message. FIG. 19 illustrates a search phase. The user C has no account for the database 201. Thus, it is conceivable that there is no access right to all items of document data in the database 201. Even when the information processing apparatus 10 performs a search based on an input message, the user C has no access right to all of corresponding files, and the user C is notified of that the corresponding files are not present. When it is determined that the database 201 (data storage unit 202) for which the user C has no account is searched, the information processing apparatus 10 causes an error message to be displayed on the terminal apparatus 20.

Even when the user C logs in, the agent can use the data storage unit 33 for search as long as the data storage unit 33 is not synchronized by the agent (as long as the data storage unit stores just document data uploaded by the user).

As described referring to the sequence diagrams of FIGS. 8 and 9, the timing at which the database 201 (data storage unit 202) for which the user C has no account is determined to be searched is a timing at which the user designates an agent after login, or a timing at which a qualified agent is determined in response to transmission of an input message.

With the present embodiment, when a user searches for document data using an agent, it is determined whether the logged-in user has an account for a database and an access right to the document data. When the user has no access right to the document data that matches the search, the information processing apparatus 10 masks (does not present) the document data. When the logged-in user has no account for the database, an error message is provided before the search. Accordingly, when the user having no account for the database or no access right to the document data uses the agent, it is possible to prevent the document data to which the user has no access right from being displayed or a response message based on the document data from being created. Thus, the information processing system 100 can maintain the security level related to the document data.

### Second Embodiment

In the present embodiment, a description is given of an information processing system 100 in which, when a user has no account for a database 5 or has no access right to document data, an agent makes an inquiry to the user about whether to use an account of another user. In the present embodiment, a description is given while assuming that the functional block diagram in FIG. 3 described in the first embodiment can be used for reference.

In the first embodiment, as illustrated in FIG. 14, when the user has no account for the database 5, the information processing apparatus 10 does not cause document data to be displayed on the terminal apparatus 20. As illustrated in FIGS. 15A and 15B, the document data to which the user has no access right is not displayed. However, when another user having an account for the database 5 or another user having an access right to the document data such as an owner of the document data (hereinafter referred to as an approval user) approves, the user may be allowed to browse the document data.

### Examples of Screen

Some examples of screens displayed by the terminal apparatus 20 will be described.

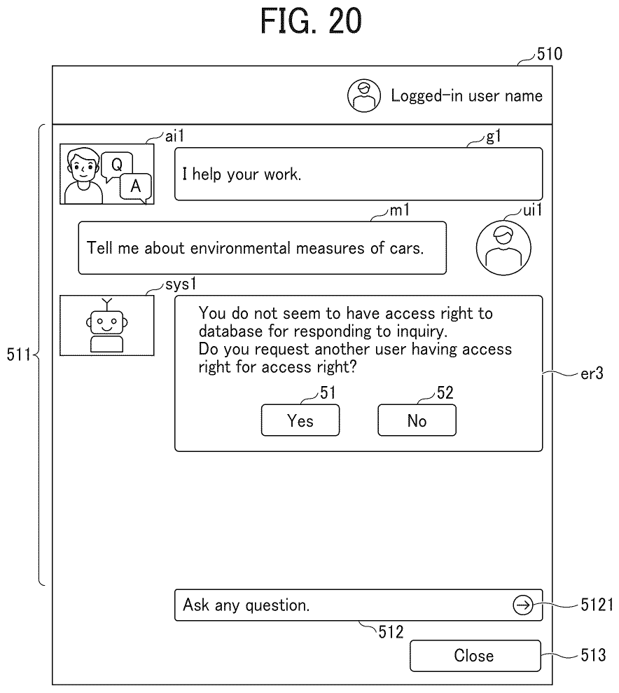

FIG. 20 illustrates an error message er3 displayed on the terminal apparatus 20 when the user has no account for the database 5. In the description of FIG. 20, the same portions as those in FIG. 14 are denoted by the same reference numerals, and the description thereof will be omitted. Similarly to FIG. 14, while the qualified agent is determined based on the input message m1, the user has no account for the database 5 associated with the agent. Thus, the display control unit 43 causes the icon sys1 and the error message er3 to be displayed.

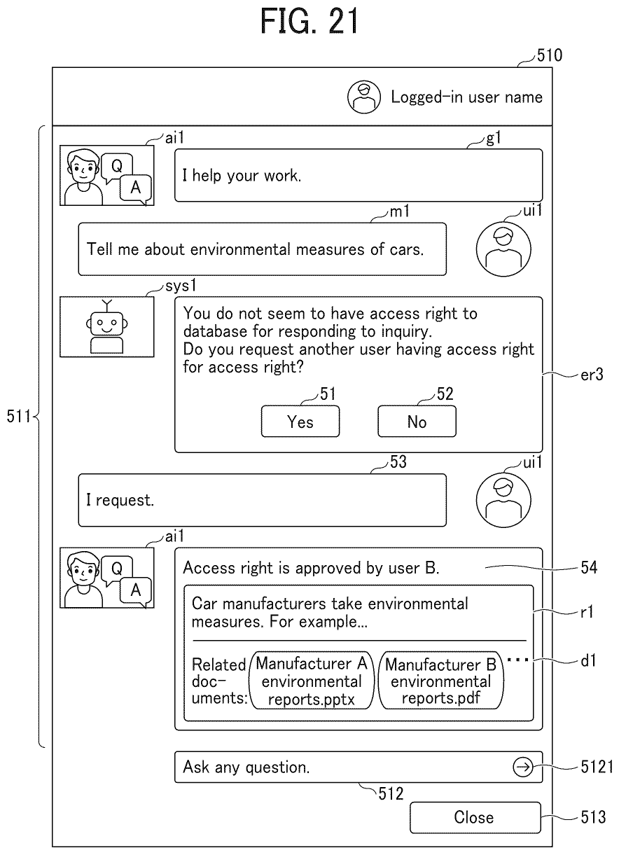

The error message er3 is, for example, “You do not seem to have access right to database for responding to inquiry. Do you request another user having access right for access right?” Accordingly, the user can recognize that the user has no account for the database 5 that stores the document data to be used by the user. In addition, the user can recognize that the user can access the database 5 (specifically, the data storage unit 33 synchronized with the database 5) when another user (approval user) permits the access. When the user uses the account of the approval user, the user presses a yes button 51. When the user does not use the account of the approval user, the user presses a no button 52. When the user presses the yes button 51 and the approval user approves the use of the account, an interactive screen 510 as illustrated in FIG. 21 is displayed.

FIG. 21 illustrates an approval message 54 displayed on the terminal apparatus 20 when the approval user approves the use of the account. First, when the user presses the yes button 51, the icon ui1 and an input message 53 “I request.” are displayed. For the description, it is assumed that the user is a “user A” and the approval user having the account for the database 5 that the qualified agent has attempted to search is a “user B.”

When the database 5 is searched using the account of the user B and there is document data that matches the input message m1, a response message r1 and related document information d1 are displayed. Together with these, an approval message 54 is displayed. The approval message 54 is, for example, “Access right is approved by user B.” The response message r1 and the related document information d1 are output information.

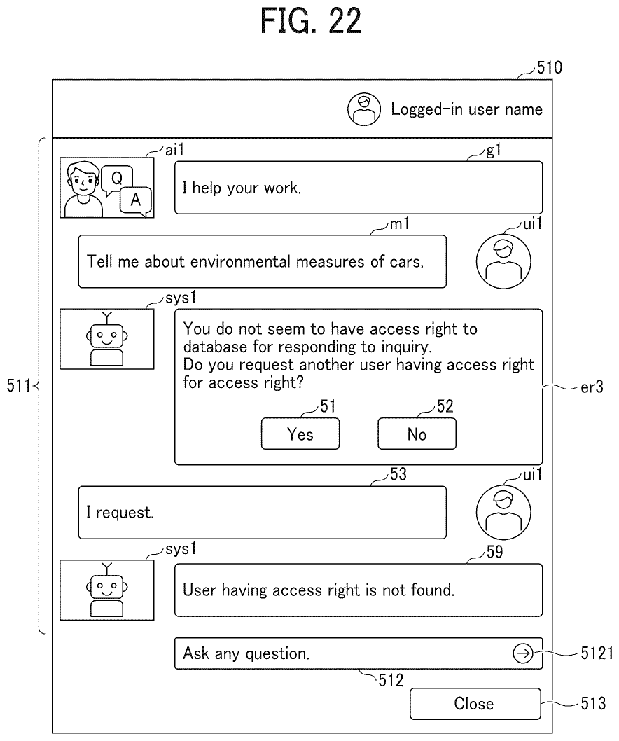

FIG. 22 illustrates an interactive screen 510 displayed on the terminal apparatus 20 when the approval user having the access right to the database 5 to be accessed by the qualified agent is not found. In this case, an icon sys1 and a message 59 “User having access right is not found.” are displayed. With reference to the message 59, the user can input another input message or switch the agent.

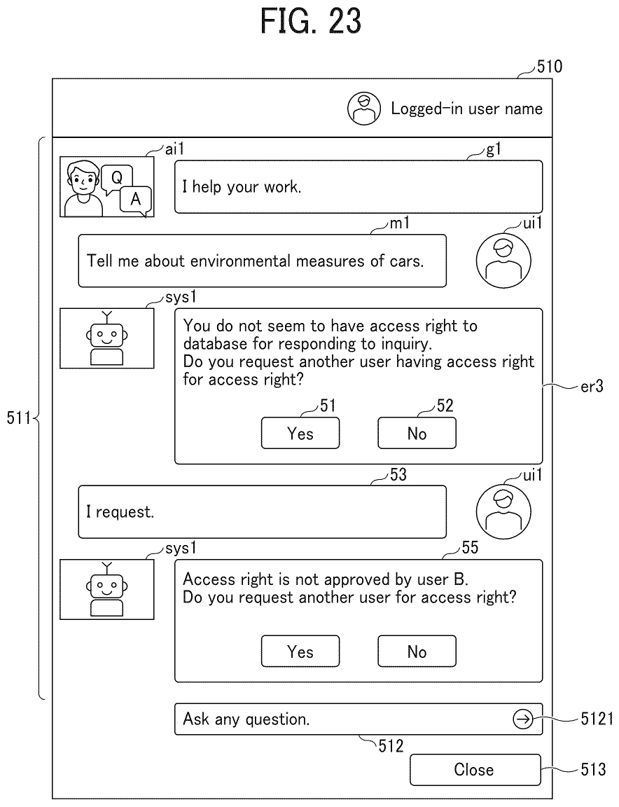

When the user presses the yes button 51 in response to the error message er3 in FIG. 20 but the approval user does not approve the use of the account, an interactive screen 510 as illustrated in FIG. 23 is displayed.

FIG. 23 illustrates a non-approval message 55 that is displayed on the terminal apparatus 20 when the use of the account is not approved. The non-approval message 55 is, for example, “Access right is not approved by user B. Do you request another user for access right?” Thus, the user can recognize that the user B has rejected the use of the account.

When there are multiple approval users having accounts for the database 5 to be accessed by the qualified agent, the display control unit 43 can display a non-approval message 55 indicating whether to make an inquiry to another approval user, such as “Do you request another user for access right?” When the user presses the yes button again, the approval message 54 in FIG. 21 or the non-approval message 55 in FIG. 23 is displayed. Thus, the user A can request the approval user to approve the use of the account as long as the approval users having the accounts for the database 5 remain.

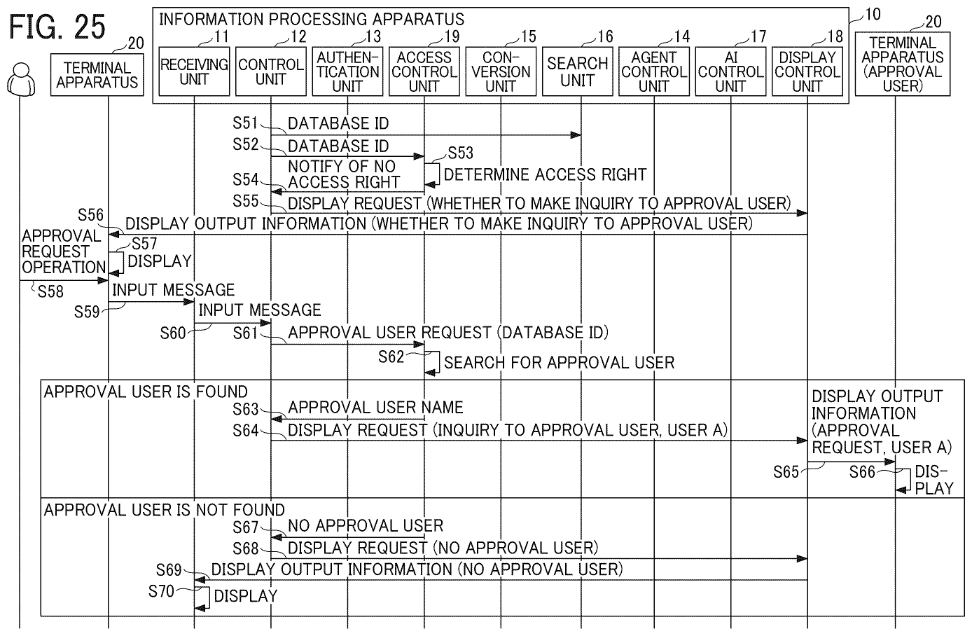

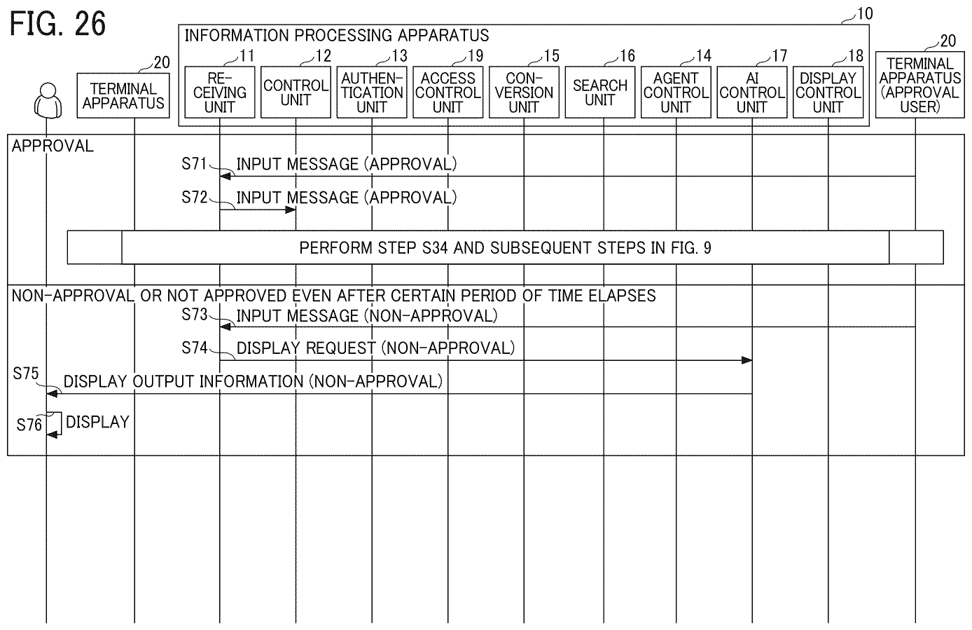

When there are multiple approval users having access rights to the database 5, as described in step S65 in the sequence diagram in FIG. 25, the information processing apparatus 10 may request approval from the multiple approval users at once, and when at least one of the multiple approval users approves, the information processing apparatus 10 may display the interactive screen 510 in FIG. 21. In this case, the non-approval message 55 indicating whether to make an inquiry to another approval user, such as “Do you request another user for access right?”, is not displayed.

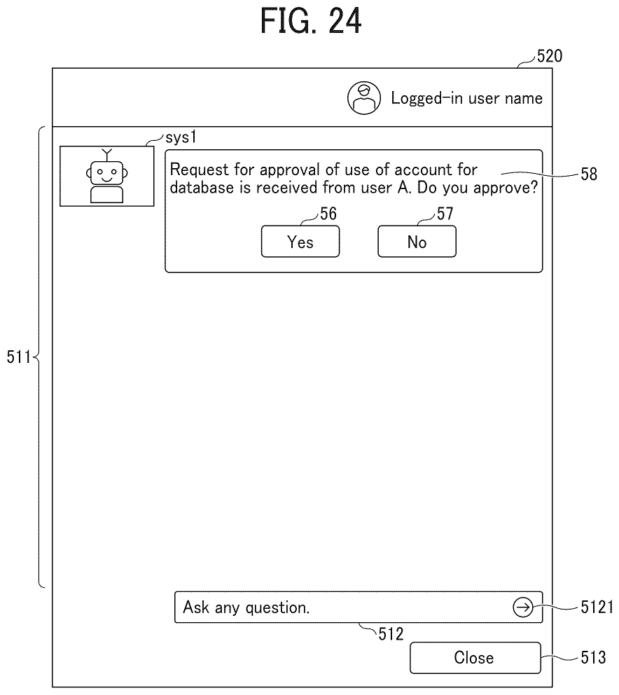

FIG. 24 illustrates an interactive screen 520 displayed on the terminal apparatus 20 operated by the approval user. In FIG. 24, an approval request message 58 “Request for approval of use of account for database is received from user A. Do you approve?”, a yes button 56, and a no button 57 are displayed. The approval user determines whether to approve the use of the account for the database 5 for the user A, and presses the yes button 56 or the no button 57. While the approval request message 58 is displayed on the interactive screen 520 in FIG. 24, the information processing apparatus 10 may make an inquiry to the approval user via an email, a social networking service (SNS), or the like.

### Operations and Processes

FIG. 25 is a sequence diagram presenting an example of operations and processes performed by the information processing system 100 when the user A has no account for the database 5. In the description of FIG. 25, similarly to FIG. 9, the process of determining whether the user has the account for the database 5 will be described first.
S51 to S53: This process may be the same as steps S31 to S33 in FIG. 9. In the present embodiment, it is assumed that the user has no account for the database 5 to be searched by the agent.
S54: Since the user has no account for the database 5 (no access right to the data storage unit 33), the access control unit 19 notifies the control unit 12 of the fact of no access right.
S55: To notify the user of the fact of no access right, the control unit 12 transmits, to the display control unit 18, a display request for output information for displaying whether to make an inquiry to the approval user.
S56: The display control unit 18 causes the output information to be displayed on the interactive screen displayed on the terminal apparatus 20. Specifically, the display control unit 18 generates display data for causing the output information to be displayed, and transmits the generated display data to the terminal apparatus 20 to cause the output information to be displayed on the interactive screen 510.
S57: The communication unit 42 of the terminal apparatus 20 receives the display data, and the display control unit 43 causes the output information to be displayed (see FIG. 20).
S58: When the user inputs an approval request operation (yes button), the receiving unit 41 receives the operation, and the communication unit 42 transmits an input message (I request, yes button) to the information processing apparatus 10. When the user presses the no button 52 in FIG. 20, the processing in FIG. 25 ends, and the user inputs a new input message.
S59: The receiving unit 11 of the information processing apparatus 10 receives the input message.
S60: The receiving unit 11 passes the input message (I request, yes button) to the control unit 12.
S61: When the yes button is pressed, the control unit 12 designates a database ID (the same as step S51) and makes an inquiry to the access control unit 19 about a user having an account for the database 5.
S62: With reference to the user information in FIG. 7, the access control unit 19 identifies an approval user having an account for the database 5 identified using the database ID. When multiple approval users having accounts for the database 5 are found, the access control unit 19 acquires all the approval users. The access control unit 19 may associate an administrator of the database 5, an approval user who has accessed the database 5 most recently, and the like with the approval user. The control unit 12 can prioritize these approval users and inquire about the use of the account.
S63: When an approval user having an account for the database 5 identified using the database ID is found, the access control unit 19 returns the approval user name to the control unit 12.
S64: To inquire of the approval user whether to approve the use of the account, the control unit 12 transmits, to the display control unit 18, a display request for output information for displaying the inquiry to the approval user.
S65: The display control unit 18 causes the output information to be displayed on the interactive screen displayed on the terminal apparatus 20. Specifically, the display control unit 18 generates display data for causing the output information to be displayed, and transmits the generated display data to the terminal apparatus 20 to cause the output information to be displayed on the interactive screen. When there are multiple approval users having access rights to the database 5, the information processing apparatus 10 may request approval from the multiple approval users at once.
S66: The communication unit 42 of the terminal apparatus 20 of the approval user receives the display data, and the display control unit 43 causes the output information to be displayed (see FIG. 24).
S67: When an approval user having an account for the database 5 identified using the database ID is not found, the access control unit 19 returns the fact of no approval user to the control unit 12.
S68: To notify the user that the approval user is not found, the control unit 12 transmits, to the display control unit 18, a display request for output information for displaying the fact of no approval user.
S69: The display control unit 18 causes the output information to be displayed on the interactive screen displayed on the terminal apparatus 20. Specifically, the display control unit 18 generates display data for causing the output information to be displayed, and transmits the generated display data to the terminal apparatus 20 to cause the output information to be displayed on the interactive screen.
S70: The communication unit 42 of the terminal apparatus 20 of the user receives the display data, and the display control unit 43 causes the output information to be displayed (see FIG. 22).

FIG. 26 is a sequence diagram presenting a flow of processing when the approval user approves and when the approval user does not approve.
S71: When the approval user presses the yes button 56 in FIG. 24, the receiving unit 41 receives the operation, and the communication unit 42 transmits an input message (approval, yes button) to the information processing apparatus 10. When there are multiple approval users having access rights to the database 5 and the information processing apparatus 10 requests approval from the multiple approval users at once, and when at least one of the multiple approval users approves the request, the information processing apparatus 10 determines approval.
S72: The receiving unit 11 of the information processing apparatus 10 receives the input message. In the case of approval, the control unit 12 can access and search the data storage unit 33, and thus the processing in step S34 and the subsequent steps in FIG. 9 is performed (see FIG. 21).
S73: In contrast, when the approval user presses the no button 57 in FIG. 24 or when the approval is not obtained even after a certain period of time elapses, the receiving unit 41 determines that the approval user does not approve, and the communication unit 42 transmits an input message (non-approval, no button) to the information processing apparatus 10.
S74: The receiving unit 11 of the information processing apparatus 10 receives the input message. In the case of non-approval, to notify the user of the fact of non-approval, a display request for output information for displaying the fact of non-approval is transmitted to the display control unit 18.
S75: The display control unit 18 causes the output information to be displayed on the interactive screen displayed on the terminal apparatus 20. Specifically, the display control unit 18 generates display data for causing the output information to be displayed, and transmits the generated display data to the terminal apparatus 20 to cause the output information to be displayed on the interactive screen.
S76: The communication unit 42 of the terminal apparatus 20 receives the display data, and the display control unit 43 causes the output information to be displayed (see FIG. 23). When there are multiple approval users having access rights to the database 5, and the information processing apparatus 10 requests approval from the multiple approval users at once but none of the multiple approval users approves, the non-approval message 55 indicating whether to inquire of another approval user as illustrated in FIG. 23 is not displayed.

### In Case of No Access Right to Document Data That Matches Search

While the processing performed when the user A has no account for the database 5 has been described with reference to FIG. 25, processing performed when the user A has no access right to document data that matches the search will be described below. The flow of processing is the same as that in FIG. 25.

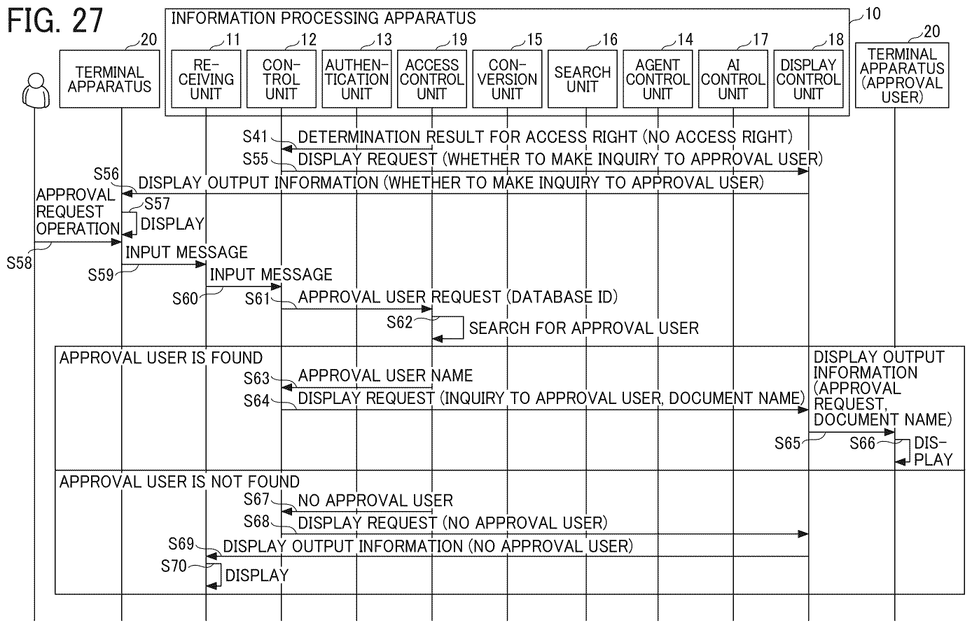

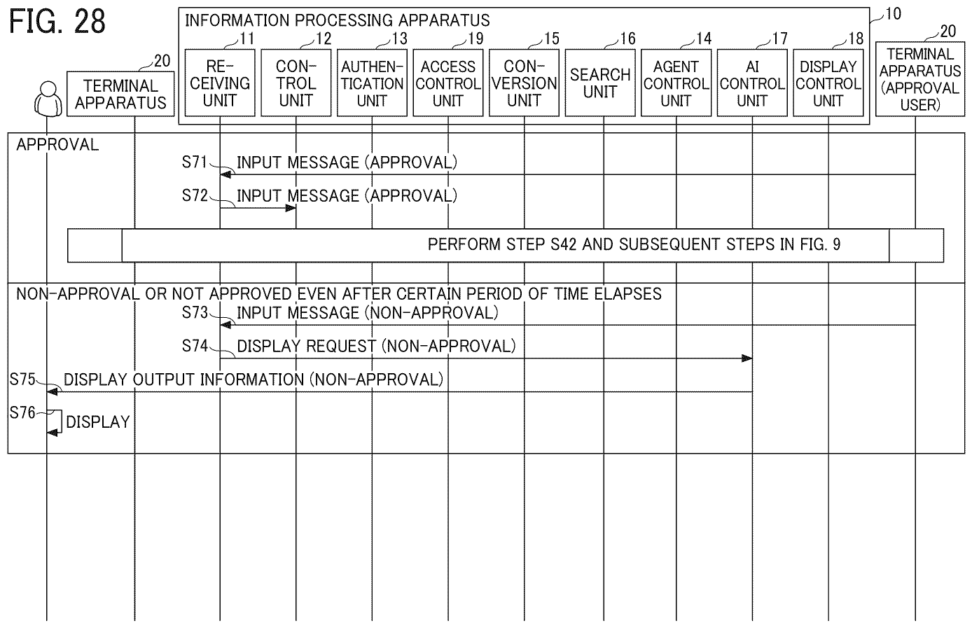

FIG. 27 is a sequence diagram presenting an example of operations and processes performed by the information processing system 100 when the user A has no access right to document data. In the description of FIG. 27, similarly to step S41 in FIG. 9, the process of determining whether the user has an access right to document data that matches the search will be described first.

As described in step S41 in FIG. 9, the access control unit 19 compares “the user having the access right” to the document data included in the search result with the logged-in user to identify the document data to which the logged-in user has the access right. It is assumed that the user has no access right to even one document data included in the search result. The subsequent processing is the same as that in FIG. 25. However, in step S62, the access control unit 19 determines the approval user having the access right to the document data included in the search result based on the chunk information in FIG. 4. Thus, the approval user may be identified for each document data, and the determination of whether to approve the document data may be different for each document data.

Multiple approval users may be found for one document data. In this case, the access control unit 19 may identify the creator of the document data as the request destination for the access right, or may identify the user who has edited the document data most recently as the request destination for the access right. The access control unit 19 may set a priority order to the approval users.

When multiple approval users are found for one document data, the control unit 12 may inquire of the multiple approval users in parallel whether to approve the access right. In this case, when at least one of the multiple approval users approves for one document data, the user can access the document data. Alternatively, an access to the document data may be limited unless all of the multiple approval users approve the access rights.

When the display control unit 43 requests the approval from the approval user in step S65, the display control unit 43 may cause the file name of the document data that matches the search and to which the approval user has the access right to be displayed on the terminal apparatus 20 of the approval user. The approval user can determine whether to approve in accordance with the document data.

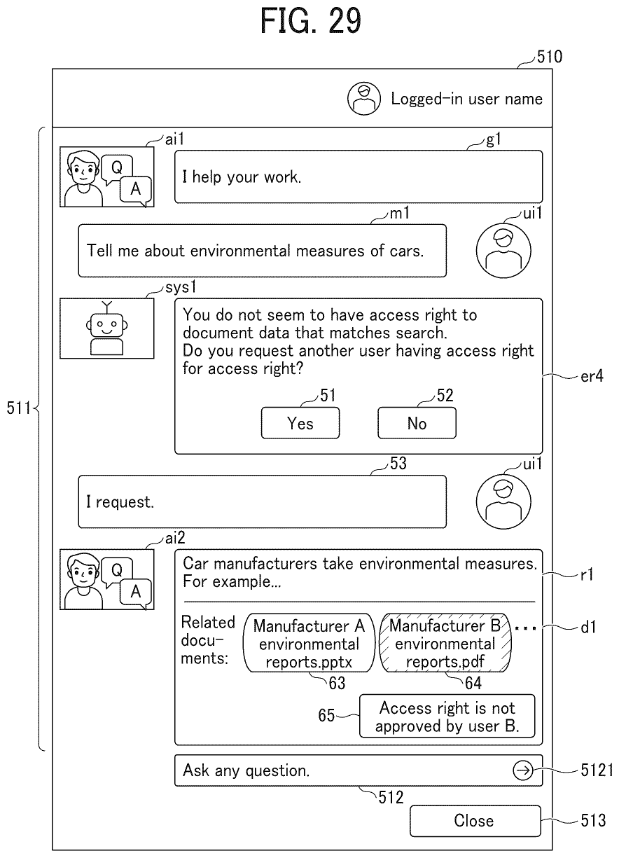

FIG. 28 is a sequence diagram presenting a flow of processing when the approval user approves and when the approval user does not approve. The flow of processing is the same as that in FIG. 26. When there is document data approved by the approval user or when there is document data to which the user has an access right in FIG. 28, step S42 and the subsequent steps in FIG. 9 are performed. In this case, an interactive screen 510 as illustrated in FIG. 29 is displayed.

FIG. 29 illustrates an interactive screen 510 displayed on the terminal apparatus 20 when the approval user does not approve the access right to document data included in the search result. Points different from those in FIG. 21 are described with reference to FIG. 29. Similarly to FIG. 14, a qualified agent is determined based on an input message m1, and items of document data that match the input message m1 are found. However, the user has no access right to some or all of the items of document data. Thus, the display control unit 43 causes an icon sys1 and an error message er4 to be displayed.

The error message er4 is, for example, “You do not seem to have access right to document data that matches search. Do you request another user having access right for access right?” Accordingly, the user can recognize that the user has no access right to the document data to be used by the user. In addition, the user can recognize that the user can access the document data when another user (approval user) permits the access. When the user uses the access right of the approval user, the user presses a yes button 51. When the user does not use the access right of the approval user, the user presses a no button 52.

When the user presses the yes button 51 and at least one approval user approves the use of the access right, a response message r1 and related document information d1 are displayed based on the approved document data. In FIG. 29, document data 63 and document data 64 that match the search are displayed. Since the user has the access right or the approval user has approved the access right, the document data 63 is displayed in a manner in which the document data 63 can be pressed. For the document data 63, whether the user has the access right or whether the access right has been approved by the approval user may be displayed.

In contrast, since the access right of the document data 64 is not approved by the approval user, the document data 64 is displayed in a manner in which the document data 64 cannot be pressed (for example, grayed out, reduced in brightness, or added with a strike-through line). A message 65 “Access right is not approved by user B.” is displayed for the document data 64. The user can recognize that the access right is not approved for the document data 64, and can negotiate with the user B.

There may be no document data to which the user has an access right, and there may be no document data approved by the approval user. In this case, for each document data, when the information processing apparatus 10 makes an approval request to multiple approval users at once, a screen like FIG. 15A is displayed. At this time, “Access is not approved for all document data.” may be displayed in the error message er2 in FIG. 15A.

When the information processing apparatus 10 makes an approval request to each approval user for each document data each time, as illustrated in FIG. 23, a non-approval message 55 for receiving whether to request another approval user to approve the use of the access right is displayed. In this case, the non-approval message 55 may be displayed for each document data.

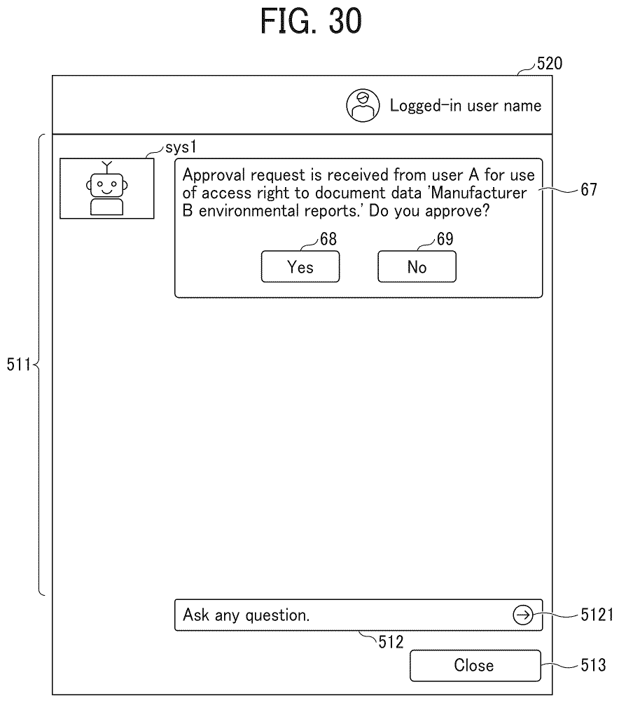

FIG. 30 illustrates an example of an interactive screen 520 displayed by the terminal apparatus 20 used by the approval user in step S66. In FIG. 30, an approval request message 67 “Approval request is received from user A for use of access right to document data ‘Manufacturer B environmental reports.’ Do you approve?”, a yes button 68, and a no button 69 are displayed. The approval user checks the document name, determines whether to approve an access to the document data for the user A, and presses the yes button 68 or the no button 69. While the approval request message 67 is displayed on the interactive screen 520 in FIG. 30, the information processing apparatus 10 may make an inquiry to the approval user via an email, a SNS, or the like.

With the present embodiment, even though the user has no access right to the database or the document data, when another user approves the access right, the agent can cause the document data searched for in the database to be displayed.

### Third Embodiment

Next, a third embodiment will be described. In the third embodiment, points different from those in the above-described embodiments are described. The third embodiment is similar to the above-described embodiments unless otherwise specified.

In the third embodiment, an example in which a terminal apparatus 20 displays various screens using a Web browser and an information processing apparatus 10 has a function as a Web server that executes a Web application will be described in detail.

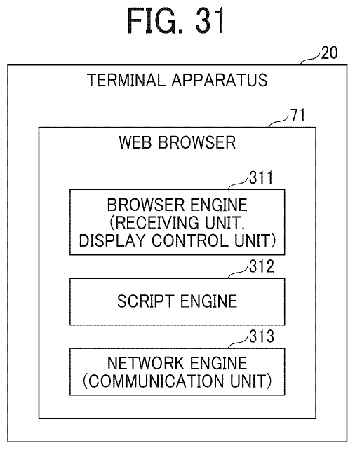

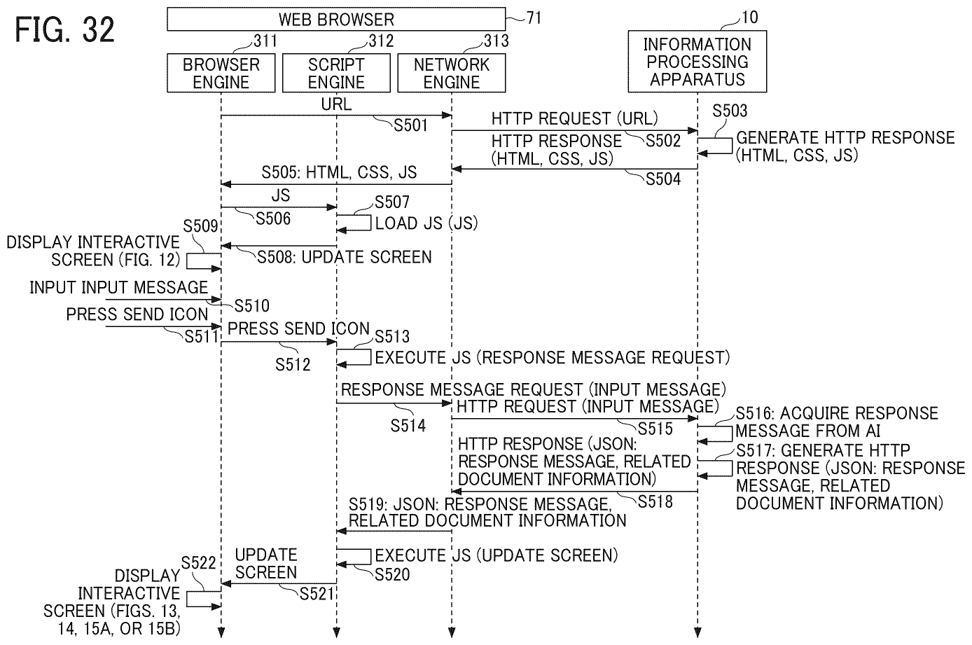

FIG. 31 is a diagram illustrating an example of a functional configuration of the terminal apparatus 20 according to the third embodiment. In FIG. 31, the terminal apparatus 20 includes a Web browser 71. The Web browser 71 is a general Web browser and includes a browser engine 311, a script engine 312, and a network engine 313.

The browser engine 311 interprets HTML data and CSS data defining a Web page, and displays the Web page. The browser engine 311 mainly corresponds to the receiving unit 41 and the display control unit 43 of the first embodiment.

The network engine 313 transmits a Hypertext Transfer Protocol (HTTP) request and receives an HTTP response. The network engine 313 mainly corresponds to the communication unit 42 of the first embodiment.

The script engine 312 executes a script (for example, JavaScript®) that defines a Web page. The script engine 312 determines how to process an input event based on the script, and executes the processing. The processing includes display and communication. For example, the script engine 312 changes the content of the screen or updates the style, and causes the display control unit 43 to display the screen. When the script engine 312 calls a communication application programming interface (API), which is, for example, XMLHttpRequest or fetch, the script engine 312 causes the communication unit 42 to transmit data, receives a response from a server as an event, and causes the response to be displayed based on the script.

FIG. 32 is a sequence diagram presenting a procedure of displaying a response message according to the third embodiment. The sequence diagram in FIG. 32 presents a procedure corresponding to step S16 and the subsequent steps in the sequence diagram in FIG. 8. However, steps S501 to S509 in FIG. 32 indicate a procedure of displaying the interactive screen 510 (FIG. 12) at the start of conversation, which is not clearly indicated in FIG. 8.

Selection of the agent by the user in step S16 in FIG. 8 corresponds to a display instruction of the interactive screen 510 (FIG. 12), and the browser engine 311 inputs, to the network engine 313, a uniform resource locator (URL) that is associated with the display instruction and that serves as a destination of an HTTP request to the information processing apparatus 10 (S501). The network engine 313 transmits the HTTP request to the URL (S502). The URL is provided from the information processing apparatus 10 as, for example, a URL of the selection destination of the agent ID. Alternatively, the URL may be registered in a bookmark of the Web browser 71, may be associated with a menu of a menu screen provided from the information processing apparatus 10, or may be directly input by the user.

The display control unit 18 of the information processing apparatus 10 generates an HTTP response including Web content data (HTML data, CSS data, and a script (hereinafter referred to as “JS”)) in response to the HTTP request (S503). The display control unit 18 transmits the HTTP response to the terminal apparatus 20 (S504).

The Web content data is an example of Web content data for displaying a first Web page (interactive screen 510 (FIG. 12)) and a second Web page (interactive screen 510 (FIGS. 13, 14, 15A, or 15B)) for displaying various messages, related document information, and the like, and includes JS that executes at least a process of causing data input on the first Web page to be transmitted to the information processing apparatus 10 and a process of causing the second Web page for displaying a response message, related document information, and the like to be displayed. In the present embodiment, it is assumed that “the response message, the related document information, and the like” include the error message in FIGS. 14, 15A, or 15B.

When receiving the HTTP response transmitted in step S504, the network engine 313 of the terminal apparatus 20 inputs the HTML data, the CSS data, and the JS included in the HTTP response to the browser engine 311 (S505). The browser engine 311 inputs the JS input from the network engine 313 to the script engine 312 (S506). The script engine 312 loads the JS (S507) and requests the browser engine 311 to update the screen (S508). Updating the screen includes displaying a new screen.

The HTTP response generated in step S503 may include a file name of the JS instead of the entity of the JS. In this case, in step S507, the script engine 312 makes an access based on the file name and downloads the JS. With this method, the JS is read as an external file.

The JS that is Web content data for displaying the first Web page (interactive screen 510 (FIG. 12)) to receive an input of an input message and the second Web page (interactive screen 510 (FIGS. 13, 14, 15A, or 15B)) for displaying a response message, related document information, and the like and that executes at least the process of causing the input message input on the first Web page to be transmitted to the information processing apparatus 10 and the process of causing the second Web page for displaying the response message, the related document information, and the like to be displayed includes the JS directly described in the HTML and the JS that causes the JS to be downloaded in response to an access based on the file name by the method of reading the JS as an external file.

The browser engine 311 displays a Web page as the interactive screen 510 (FIG. 12) based on the HTML data and the CSS data (S509).

The interactive screen 510 (FIG. 12) is one Web page in a single-page application (a Web application having one Web page). In step S511 and the subsequent steps, the content is updated for the one Web page, and FIGS. 13, 14, 15A, or 15B is displayed.

When the user inputs an input message to the interactive screen 510 (FIG. 12) (S510) and presses the send icon 5121 (S511), the browser engine 311 notifies the script engine 312 of the pressing of the send icon 5121 (S512). The script engine 312 executes the JS in response to the notification from the browser engine 311 (S513). When the send icon 5121 is pressed, the script engine 312 inputs a request for a response message to the network engine 313 (S514). The request includes the input message. The network engine 313 transmits an HTTP request as the request for the response message to the information processing apparatus 10 (S515). The HTTP request is an HTTP request transmitted by the JS being executed by the terminal apparatus 20, and is an example of the HTTP request including data input on the interactive screen 510 (FIG. 12) displayed on the terminal apparatus 20 based on the Web content data.

When receiving the HTTP request, the AI control unit 17 of the information processing apparatus 10 generates a prompt as described in step S43 in FIG. 9, and acquires a response message from the AI 150 (S516).

The display control unit 18 generates an HTTP response including JavaScript® Object Notation (JSON) in which a response message, related document information, and the like are described in order to display the interactive screen 510 (FIGS. 13, 14, 15A, or 15B) when the terminal apparatus 20 executes the JS (S517). The display control unit 18 transmits the HTTP response to the terminal apparatus 20 (S518).

When receiving the HTTP response, the network engine 313 of the terminal apparatus 20 inputs the response message, the related document information, and the like included in the HTTP response to the script engine 312 (S519). The script engine 312 executes the JS (S520). The script engine 312 requests the browser engine 311 to update the display content of the Web page as a process when the response message, the related document information, and the like are received (S521). Based on the HTML data and the CSS data acquired in step S505, the browser engine 311 displays the interactive screen 510 (FIGS. 13, 14, 15A, or 15B) that is the updated screen (S522).

As described above, in the third embodiment, the interactive screen 510 (FIG. 12) and the interactive screen 510 (FIGS. 13, 14, 15A, or 15B), and execution of processing in accordance with an operation on each of these screens are implemented by a single-page application. Specifically, when the interactive screen 510 (FIG. 12) is displayed, the Web content data that is not for displaying just the interactive screen 510 (FIG. 12), but that is for displaying the interactive screen 510 (FIG. 12) and the interactive screen 510 (FIGS. 13, 14, 15A, or 15B), and that includes the JS to execute processing such as screen transition in accordance with an operation on the interactive screen 510 (FIGS. 12, 13, 14, 15A, or 15B) is distributed to the terminal apparatus 20. Thus, since the screen transition to the interactive screen 510 in FIGS. 13, 14, 15A, or 15B is performed by the JS, the terminal apparatus 20 does not have to download the Web content data of the interactive screen 510 in FIGS. 13, 14, 15A, or 15B each time. As a result, technical problems such as an increase in the display speed of the interactive screen 510 of FIGS. 13, 14, 15A, or 15B and a reduction in the communication load in screen transition can be expected to be solved.

While the screen transition according to the first embodiment has been described as an example in the present embodiment, the screen transition according to the second embodiment can also be applied. In this case, the Web content data for displaying the interactive screen 510 (FIG. 12) includes the Web content data for displaying the interactive screens 510 and 520 (FIGS. 20 to 25, 29, and 30).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, the access control unit 19 determines whether the user has the access right to the document data extracted by the search unit 16 searching the data storage unit 33. However, the access control unit 19 may identify the document data to which the user has the access right in the data storage unit 33 before the search, and the search unit 16 may search for the identified document data.

When the database 5 is not present, the synchronization with the data storage unit 33 does not have to be performed. For example, there is a case where the data storage unit 33 is a storage unit that is a direct update target of document data. Also in this case, the search unit 16 may search the data storage unit 33, and the access control unit 19 may determine the access right to the document data.

The configuration example in FIG. 3 and the like is divided in accordance with main functions to facilitate understanding of the processes performed by the terminal apparatus 20 and the information processing apparatus 10. No limitation to a scope of the present disclosure is intended by how the processes are divided or by the name of the processes. The processes of the terminal apparatus 20 and the information processing apparatus 10 may be divided into more units of processes in accordance with the content of process. Alternatively, one unit of process may be a group of divided processes.

For example, in the functional block diagram of FIG. 3, the information processing apparatus 10 and the terminal apparatus 20 may be integrated. All or some of the functional blocks of the information processing apparatus 10 may be included in the terminal apparatus 20. With this configuration, even in an environment such as an offline environment, the user can have conversation with the AI 150. Alternatively, an external device may be used as the AI 150 or the data storage unit 33, and the AI 150 or the data storage unit 33 may be excluded from the information processing apparatus 10 or the terminal apparatus 20. Accordingly, the user can utilize an external resource (database, AI), and the accuracy of a response by the interactive AI is increased.

The apparatuses or devices described in one or more embodiments are just one example of multiple computing environments that implement the one or more embodiments disclosed herein. In some embodiments, the information processing apparatus 10 includes multiple computing devices, such as a server cluster. The multiple computing devices are configured to communicate with one another through any type of communication link, including a network, a shared memory, etc., to collectively perform the processes disclosed herein.

Moreover, the information processing apparatus 10 may be configured to share the processing steps disclosed, e.g., in FIGS. 8 and 9, in various combinations. For example, a process performed by a predetermined unit may be performed by multiple information processing devices included in the information processing apparatus 10. Further, the components of the information processing apparatus 10 may be combined into one server apparatus, or divided into multiple machines in combinations.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The present disclosure includes the following aspects.

According to Aspect 1, an information processing system includes a receiving unit that receives an input of an input message to an interactive AI that interacts with a user who has logged in; a search unit that searches a data storage unit that stores information related to access rights and items of electronic data based on the input message to obtain a search result; and a display control unit that causes, as a response of the interactive AI to the input message, electronic data to which the user has an access right among the items of electronic data stored in the data storage unit to be displayed based on the search result obtained by the search unit.

According to Aspect 2, the information processing system of Aspect 1 further includes an access control unit that identifies, based on the search result obtained by the search unit, the electronic data to which the user has the access right among the items of electronic data stored in the data storage unit.

According to Aspect 3, the information processing system of Aspect 1 or Aspect 2 further includes an AI control unit that transmits the input message, and at least a portion of the electronic data to which the user has the access right among the items of electronic data stored in the data storage unit to an AI based on the search result obtained by the search unit, and acquires a response message from the AI as a response to the input message. The display control unit causes the response message to be displayed.

According to Aspect 4, in the information processing system of any one of Aspect 1 to Aspect 3, the data storage unit is synchronized with an external database.

According to Aspect 5, in the information processing system of Aspect 2, the search unit calculates degrees of similarity between the input message and the items of electronic data stored in the data storage unit; when top N items of electronic data having high degrees of similarity do not include the electronic data to which the user has the access right, the access control unit determines whether N items of top N+1 or less items of electronic data include the electronic data to which the user has the access right; and when the N items of the top N+1 or less items of electronic data do not include the electronic data to which the user has the access right, the display control unit causes an error message to be displayed.

According to Aspect 6, in the information processing system of Aspect 2, based on information related to a database for which the user has an account, and information in which identification information of a database synchronized with the data storage unit to be searched by the interactive AI is registered, the access control unit determines whether the user who has logged in has an account for the database identified using the identification information; and when the user who has logged in does not have the account, the display control unit causes an error message to be displayed before the search unit searches the data storage unit based on the input message.

According to Aspect 7, in the information processing system of Aspect 6, the interactive AI is determined based on the input message.

According to Aspect 8, in the information processing system of any one of Aspect 1 to Aspect 5, the interactive AI acquires electronic data from a database synchronized with the data storage unit using an account of a first user associated with the interactive AI in advance, and stores the electronic data in the data storage unit, the electronic data stored in the data storage unit includes, as the information related to the access rights, a fact that the first user has an access right, and the display control unit causes the electronic data to which the first user has the access right to be displayed when the search unit searches the data storage unit based on an input message input by the first user.

According to Aspect 9, in the information processing system of Aspect 8, the electronic data stored in the data storage unit includes, as the information related to the access rights, a fact that a second user originally registered in the database as having an access right has the access right, and the display control unit causes the electronic data to which the second user has the access right to be displayed when the search unit searches the data storage unit based on an input message input by the second user.

According to Aspect 10, in the information processing system of Aspect 6, the access control unit determines whether the user who has logged in has an access right to the database identified using the identification information or the access right to the electronic data based on the search result obtained by the search unit; when the user does not have the access right, the access control unit inquires another user having the access right whether to approve an access of the user to the database or the electronic data based on the search result obtained by the search unit; and when receiving approval from said another user, the display control unit causes the electronic data searched by the search unit to be displayed.

According to Aspect 11, in the information processing system of Aspect 6, the access control unit determines whether the user has the access right to the electronic data based on the search result obtained by the search unit; and the display control unit causes a file name of electronic data to which the user does not have an access right among the items of electronic data based on the search result obtained by the search unit based on the input message, in a manner in which pressing of the file name is not acceptable.

According to Aspect 12, in the information processing system of Aspect 1, the information processing system is an information processing system including a terminal apparatus and an information processing apparatus. The terminal apparatus includes the receiving unit and the display control unit. The information processing apparatus includes the search unit.

1. An information processing system comprising:
a memory that stores information related to access rights and electronic data; and
circuitry configured to:
receive an input of an input message to an interactive artificial intelligence (AI) that interacts with a user who has logged in;
search the memory based on the input message to obtain a search result; and
display, on a display, electronic data to which the user has an access right among the electronic data stored in the memory, as a response of the interactive AI to the input message, based on the search result.

2. The information processing system according to claim 1, wherein the circuitry is configured to identify the electronic data to which the user has the access right among the electronic data stored in the memory based on the search result.

3. The information processing system according to claim 1, wherein the circuitry is configured to:
transmit the input message, and at least a portion of the electronic data to which the user has the access right to the AI based on the search result;
acquire a response message from the AI as a response to the input message; and
display the response message on the display.

4. The information processing system according to claim 1, wherein the memory is synchronized with an external database that is external to the information processing system.

5. The information processing system according to claim 2, wherein the circuitry is configured to:
calculate, for each of the electronic data stored in the memory, a degree of similarity between the input message and the electronic data;
in a case where top N items of electronic data having high degrees of similarity do not include the electronic data to which the user has the access right, determine whether N items of top N+1 or less items of electronic data include the electronic data to which the user has the access right; and
in a case where the N items of the top N+1 or less items of electronic data do not include the electronic data to which the user has the access right, display an error message.

6. The information processing system according to claim 2, wherein, based on information related to a database for which the user has an account, and information in which identification information of a database synchronized with the memory to be searched by the interactive AI is registered, the circuitry is configured to:
determine whether the user who has logged in has an account for the database identified using the identification information; and
in a case where the user who has logged in does not have the account, display an error message before searching the memory based on the input message.

7. The information processing system according to claim 6, wherein the circuitry is configured to determine the interactive AI based on the input message.

8. The information processing system according to claim 1,
wherein the circuitry is configured to activate the interactive AI, acquire electronic data from a database synchronized with the memory using an account of a first user having been associated with the interactive AI, and store the electronic data in the memory,
wherein the electronic data stored in the memory includes, as the information related to the access rights, a fact that the first user has an access right, and
wherein the circuitry is configured to display the electronic data to which the first user has the access right when searching the memory based on an input message input by the first user.

9. The information processing system according to claim 8,
wherein the electronic data stored in the memory includes, as the information related to the access rights, a fact that a second user originally registered in the database as having an access right has the access right, and
wherein the circuitry is configured to display the electronic data to which the second user has the access right when searching the memory based on an input message input by the second user.

10. The information processing system according to claim 6, wherein the circuitry is configured to:
determine whether the user who has logged in has an access right to the database identified using the identification information or the access right to the electronic data based on the search result;
in a case where the user does not have the access right, inquire another user having the access right whether to approve an access of the user to the database or the electronic data based on the search result; and
in response to receiving approval from said another user, display the searched electronic data.

11. The information processing system according to claim 6, wherein the circuitry is configured to:
determine whether the user has the access right to the electronic data based on the search result; and
display a file name of electronic data to which the user does not have an access right among the electronic data based on the search result based on the input message, in a manner in which the file name is not selectable by the user.

12. The information processing system according to claim 1,
wherein the circuitry includes:
first circuitry in a terminal apparatus; and
second circuitry in an information processing apparatus,
wherein the first circuitry is configured to perform a process of the reception and a process of the display, and
wherein the second circuitry performs a process of the search.

13. An information processing apparatus comprising circuitry configured to:
receive an input of an input message to an artificial intelligence (AI) that interacts with a user who has logged in;
search a memory that stores information related to access rights and electronic data based on the input message to obtain a search result; and
display, on a display, electronic data to which the user has an access right among the electronic data stored in the memory, as a response of the interactive AI to the input message, based on the search result.

14. An information processing method comprising:
receiving an input of an input message to an interactive artificial intelligence (AI) that interacts with a user who has logged in;
searching a memory that stores information related to access rights and electronic data based on the input message to obtain a search result; and
displaying, on a display, electronic data to which the user has an access right among the electronic data stored in the memory, as a response of the interactive AI to the input message, based on the search result.
